(19) United States
(12) Patent Application Publication
(10) Pub. No.: US 2008/0155386 A1
(43) Pub. Date: Jun. 26, 2008

(54) NETWORK DISCOVERY SYSTEM

(75) Inventor: Robert JENSEN, Fredericia (DK)

Correspondence Address: PILLSBURY WINTHROP SHAW PITTMAN, LLP, P.O. BOX 10500, MCLEAN, VA, 22102, US

(73) Assignee: AutIQ AS, Fredericia (DK)

(21) Appl. No.: 11/960,970

(22) Filed: Dec. 20, 2007

Related U.S. Application Data
(60) Provisional application No. 60/871,479, filed on Dec. 22, 2006.

(51) Int. Cl. G06F 15/173; G06F 3/14

(52) U.S. Cl. 715/201; 709/224

(57) ABSTRACT

The present application relates to a system for enhancing management of a network, including discovery of resources and management of agents.

The present application claims priority to U.S. Provisional Application No. 60/871,479, filed Dec. 22, 2006, the entirety of which is incorporated into the present application by reference.

### FIELD OF THE INVENTION

The present invention relates to a system for enhancing management of a network, including discovery of resources and management of agents.

### BACKGROUND OF THE INVENTION

As companies become larger and more complex, the computer networks serving them likewise become more complex, often exponentially more complex than the growth of the company itself. Service oriented network architectures are one type of network becoming more prevalent in today's computer networks. Service oriented network architectures are advantageous because they use the same service objects in the network to support various processes. In this programming architecture, processes that have identical sub-functions may call upon the same program to perform the sub-function. This is opposed to building each process in the network from the ground up, and incorporating each specific sub-function of the process into the process object itself.

Each process in a service oriented architecture uses a different process object to manage the associated tasks, and where the tasks are the same they may use the common service objects on the network—as opposed to having to program the common tasks into each application process object, which leads to duplication and wasted resources. FIG. 1 provides a highly simplistic schematic of a network developed with a service oriented architecture. This schematic is provided simply to provide a general idea of how network resources are shared, and is not intended to be limiting. A functional network may have thousands or millions of “nodes” or network resources (which would be impractical to illustrate). But each of these networks are characterized by the use of service objects to provide encapsulated functionality, and process objects and/or other network resources may use those service objects. As in any network, the primary goal is to serve the users, and they are represented as well in FIG. 1. As can be seen from this simplistic schematic, process objects (PROCESS OBJECTS A-C) may share service objects (SO1-8).

For a rudimentary example, consider a financial institution that automates both its credit card and home loan approval processes. In this example, the home loan process may comprise the following basic functions: input personal data for the loan applicant; input data relating to the collateral (i.e., the home being purchased); run a credit check on the applicant; order an appraisal for the collateral; and provide a report approving or disapproving the loan application. And the credit card approval process may likewise comprise the following basic functions: input personal data for the applicant; run a credit check on the applicant; and provide a report approving or disapproving the credit card application. Here, while the overall processes are different, they share the common functions of inputting personal data for the applicant and running a credit check on the applicant.

In a traditional programming architecture, each of these processes would be built as an incorporated unit, with each process having its own credit check and applicant data input functions. Not only does this create duplicative programming and wasted resources, but the user at the institution may have to learn two entirely different ways of entering data if the programs are structured differently. Also, changes to the common functions require twice (or more) as much effort, since they are duplicated.

With a service oriented programming architecture, each of these processes would be managed by its own software program referred to as a process object. A process object is an encapsulated software program that performs and manages a series of distinct tasks, and may call on one or more service objects to perform one or more of those tasks. With regard to the previous examples, the home loan process and the credit card application process would each be managed by its own process object. However, the common functions, such as the credit check function, could be assigned to a separate program, referred to as a service object. A service object is a software program that performs a specified function and is used by process objects, but itself does not use other service objects. A service object may drive hardware in the network, such as a fax machine for sending out an order to a third party appraiser or a user terminal for displaying a report. Here, the credit check function could be developed as its own service object, and both the home loan and credit card process objects could use that service object to obtain the credit check needed to complete their respective tasks.

Another example may be the calculation of sales taxes. In a retail store chain with locations all over the U.S. (or even worldwide), sales taxes may be imposed on certain sales. As sales tax laws may change from jurisdiction to jurisdiction, instead of attempting to update each store (or even each cash register terminal) in each jurisdiction, the network could be designed to have the sales tax calculations performed by encapsulated service objects. Each time sales tax regulation or law changes, that service object can simply be updated, thus requiring no change to the remaining portions of the network.

A shortcoming of this service oriented architecture is that, as a network grows in complexity, the dependencies between process and service objects, as well as other network resources, becomes exponentially complex to understand and manage. This is the burden of the IT department, and significant resources must be devoted to having an even basic understanding of a complex network. This problem also exists in more traditional network architectures as well.

Another significant problem in any complex network is tracking and managing any changes in the network, and particularly in the network resources. Any understanding of the functioning of a network can only be as valid as the currency of the data reflecting the current network status.

The inventions of the present application endeavor to provide one or more unique tools to better collect information and understand the intricacies of a complex network, including but not limited to those using this service oriented architecture approach.

### SUMMARY OF THE INVENTION

One aspect of the invention provides a method for managing usage of service objects in a network comprising network resources including the service objects. Each service object is configured to be used by other network resources to perform a specified function. The method is computer-implemented and comprises:

monitoring a usage of each service object to determine at least (a) a usage level for each service object, and (b) an identity of each network resource using the service object; and

storing the information determined by said monitoring, the information including for each service object at least (a) the usage level for each service object, and (b) the identity of each network resource using the service object.

Another aspect of the invention comprises a method for managing usage of process objects in a network comprising network resources including service objects and the process objects. Each service object is configured to perform a specified function and further is configured to be used by other network resources including the process objects. Each process object comprises executable code for performing a process including using one or more of the service objects. The method is computer-implemented and comprises:

monitoring a usage of each process object to determine at least (a) a usage level for the process object, (b) an identity of each network resource using the process object, and (c) an identity of each service object used by the process object; and

storing the information determined by said monitoring, the information including for each process object at least (a) the usage level for the process object, (b) the identity of each network resource using the process object, and (c) the identity of each service object used by the process object.

Another aspect of the invention provides a system for managing usage of service objects in a network comprising network resources including the service objects. Each service object is configured to be used by other network resources to perform a specified function. The system comprises a monitor for monitoring a usage of each service object to determine at least (a) a usage level for each service object, and (b) an identity of each network resource using the service object; and a database for storing the information determined by said monitoring, the information including for each service object at least (a) the usage level for each service object, and (b) the identity of each network resource using the service object.

Another aspect of the invention provides a system for managing usage of process objects in a network comprising network resources including service objects and the process objects. Each service object is configured to performed a specified function and further is configured to be used by other network resources including the process objects. Each process object comprises executable code for using one or more of the service objects. The system comprises: a monitor for monitoring a usage of each process object to determine at least (a) a usage level for the process object, (b) an identity of each network resource using the process object, and (c) an identity of each service object used by the process object; and a database for storing the information determined by said monitoring, the information including for each process object at least (a) the usage level for the process object, (b) the identity of each network resource using the process object, and (c) the identity of each service object used by the process object.

Other objects, features, and advantages of the present invention will become apparent from the following detailed description, the accompanying drawings and the appended claims.

### BRIEF DESCRIPTION OF THE DRAWINGS

FIG. 1 is a schematic representation of a service oriented architecture based network;

FIG. 2 is a schematic representation of a system coupled to a network;

FIG. 3 is a flowchart for an alert process;

FIG. 4 is a flowchart for another alert process;

FIG. 5 is a flowchart for a load distributing process;

FIG. 6 is a flowchart for deploying active agents in a network;

FIG. 7 is a flowchart for undeploying active agents from a network;

FIG. 8 is a flowchart for managing an agent message queue; and

FIG. 9 is a flowchart for managing an event specification queue.

### DEFINITIONS

To understand the terminology used in this application, the following definitions are being provided:

“Network Resource”: any hardware or software used in the network. For example, a network resource may be a printer, user terminal, fax machine, scanner, server, router, administrator terminal, service level agreements, contracts, or any application or operating system. Any network resource that is characterized as a software program means that is constituted by executable code. Network resources include process and service objects. A network resource may also be a person or group of people in the sense that a person logged into the network via a terminal typically has an identification within the network (in the form of a user name or other identification). The person or people per se would not be regarded as a resource, but the identity of the person or people on the network would be regarded as a resource, as they call on and access resources (such as process objects) via terminals.

“Object”: a software program (i.e., executable code) that performs one or more functions.

“Process object”: a software program configured to perform or manage the performance of a series of interrelated functions or tasks, and calls upon at least two other objects to perform its functions or tasks. A process object may perform one or more of the functions or tasks itself, but it would call upon one or more service objects or other process objects to perform functions on its behalf. A function or task may include receiving data from, or reporting data, to a person or people on the network, and the identity of that person or people may be regarded as a network resource using the process object.

“Service object”: a software program that performs a discrete function or task (or discrete interrelated tasks) on behalf of a process object. A service object does not call upon multiple other objects, but it may drive hardware in the network as part of the performance of its function or task, or it may use another service object to perform a function or task subsequent to or as part of performing its own function or task. For example, a service object may cause a printer to print out reports for manual distribution to personnel in the network's company as part of the process. Or it may generate a report and call upon an e-mail program to send the report out to one or more recipients on its behalf. If the object is calling upon more than one other object, then it is a process object as defined above. Because a service object is a discrete program, it is often referred to as being encapsulated.

“Loose connection”: a temporary connection between two network resources. For example, when a process object calls upon a service object to perform a calculation and receives the data from the service object, that is a temporary (i.e., loose) connection.

“Direct loose connection”: a loose connection that is direct, e.g., the process object calls directly on the service object.

“Indirect loose connection”: a loose connection that is indirect, e.g., when a process object A calls on a process object B, and then process object B calls on a service object C, there is an indirect loose connection between process object A and the service object C (but there is a direct loose connection between process object B and the service object C).

“Relation”: a fixed association between two network resources. For example, an operating system that runs on a server is related to the server, and a service object that runs in the operating system environment is related to both the server and the operating system.

“Direct relation”: a relation directly between two network resources. For example, the operating system of the server runs on the server, and thus is directly related to the server. And the service object that runs in the operating system environment is directly related to the operating system (but is not directly related to the server because it is indirectly related to the server through the interface provided by the operating system).

“Indirect relation”: a relation indirectly between two network resources. For example, the service object that runs in the environment of the operating system on the server has a direct relation with the operating system as noted above, and an indirect relation with the server.

These terms are consistent with terminology used in the art. However, because terminology in the art may change as service oriented architecture technology continues to evolve, these definitions are provided to provide a clear understanding of how these terms are being used in this application and the appended claims.

### DETAILED DESCRIPTION OF PREFERRED EMBODIMENT(S) OF THE INVENTION

The present invention may be applied to any type of network incorporating in whole, or in part, a service oriented architecture in its application programming. The present invention is not intended to be limited to any specific type of network, or any specific type of business using such a network. To the contrary, the broad principles of the present invention may be applied to any type of network, and to networks of any size or level of complexity.

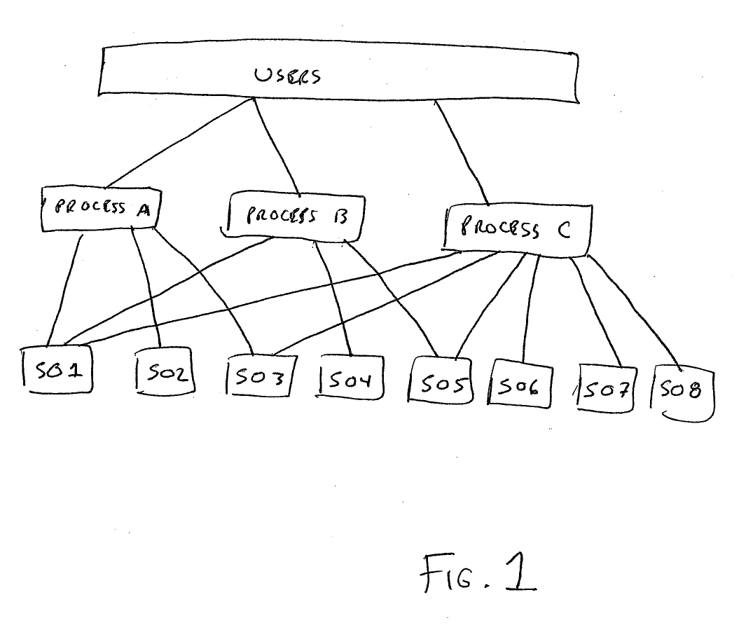

FIG. 1 provides a highly simplistic schematic of a network developed with a service oriented architecture. This schematic is provided simply to provide a general idea of how network resources are shared, and is not intended to be limiting. A functional network may have thousands or millions of “nodes” or network resources (which would be impractical to illustrate). But each of these networks are characterized by the use of service objects to provide encapsulated functionality, and process objects and/or other network resources may use those service objects. As in any network, the primary goal is to serve the users, and they are represented as well in FIG. 1. As can be seen from this simplistic schematic, process objects (PROCESS OBJECTS A-C) may share service objects (SO1-8).

One aspect of the present invention relates to the ability to discover and manage information concerning service objects in the network architecture. Because service objects perform many of the functions or tasks in the network, and are shared as resources by other network resources (including process objects), it is important to understand the usage, location, connections, and relationships for each service object. As discussed above, a single function performed by a single service object may support many key processes in the network, and thus that object by itself may play a critical support role. Thus, the ability to understand the interplay between a service object and the remainder of the network resources is important to understanding the performance and structure of the overall network.

In general, this aspect of service discovery is a method for managing usage of service objects in a network, where the network comprises network resources including the service objects. The method comprises the following basic acts:

monitoring a usage of each service object to determine at least (a) a usage level for each service object, and (b) an identity of each network resource using the service object; and

storing the information determined by said monitoring, the information including for each service object at least (a) the usage level for each service object, and (b) the identity of each network resource using the service object.

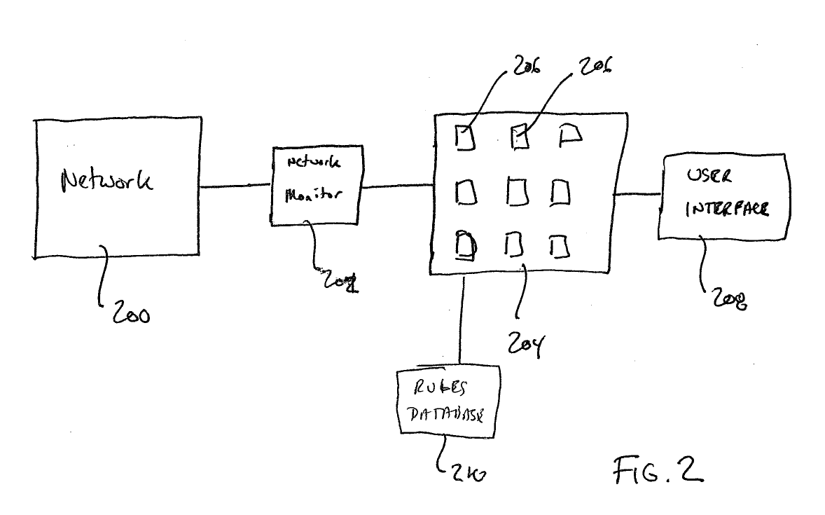

The monitoring may be conducted in any computer implemented manner. One embodiment contemplates that the monitoring may be conducted by a network monitor, which is a software program that runs on a shared or dedicated server. The network monitor, shown at 202 in FIG. 2, may be coupled between a profile database 204 containing a series of profiles 206 and the remainder of the network 200. As used herein, “coupled” means any capability for connecting to transmit data, and may be on demand and need not be a permanent continuous connection. The profile database is a database on a server that includes a management program (referred to as a database manager) for accessing the data in the profiles, writing data to the profiles, and analyzing the profiles in the manner discussed below. Such a database may be a configuration management database. The database 204 may also be coupled to a user interface 208 (either directly or through the network monitor), which may be a network administrator terminal (or a set thereof), for purposes of allowing the network administrator to interact with the database, generate and view reports, maintain the database, and/or receive alerts. In other embodiments, the user interface may be typical user terminals (i.e., regular users or PCs, and not necessarily personnel from the IT department) that need access to information in the profile database 204, as well.

The network monitor 202 may comprise distinct or integrated sub-components, and its functionality may be distributed among various different components and need not be a monolithic object. Its basic functions are to receive data concerning changes in the network and transmit that to the profile database, and to analyze the profiles in the database to make decisions, alerts, etc. as described below. For example, in some embodiments, the functions of receiving data from the network may be handled by one component (i.e., a data receiving monitor), and the functions of analyzing the database to make decisions, etc. based on the knowledge of the network stored in the database may be handled by a separate component (i.e., a data analysis monitor), both of which may be considered collectively as a monitor. In some of the embodiments, some of the monitor's analytical functions may be performed by the database manager (such as those that “run behind the scenes”). Thus, the database manager may be regarded as part of the monitor in general.

FIG. 2 is a very schematic representation of this basic structure for monitoring and is not intended to be limiting. To the contrary, FIG. 2 is merely a schematic representation, and a real world execution may be much more complex. For example, in a complicated corporate network distributed globally, the network monitoring may be performed by a plurality of network monitors 202 that are dedicated to certain parts of the network 200, or different interconnected sub-networks. And sub-functions if the monitor may become so complex and computationally intensive that the can be distributed to discrete components (any may run on their own dedicated servers). Likewise, multiple monitors may be used in parallel with a failover capability so that monitoring capabilities are not lost. Also, the network monitor, database manager, and/or profile database may be implemented on a common server or set of servers, and the representation of separate components in the drawings is not intended to be limiting. And the database manager may be on a dedicated server that controls access, reading and writing to the database which is on a separate database server. The database manager may also handle the interface between the user interface 208 and the database 206, or that interfacing may be handled by a separate user interface manager, which is a program dedicated to handling requests from the user interface, and the generation of reports, transmittal or alerts, etc. to the user interface. Depending on the business's cost and performance needs, various structures for implementing the hardware may be used, as relatively small networks may benefit from a different structure than a very large network.

In the profile database 204, a profile 206 is created for each network resource in the network. As network resources are added to or removed from the network, corresponding profiles 206 may be added to or deleted from the database 204. In some embodiments, this may be done manually, but in other embodiments it may be carried out automatically. Each profile 206 will contain data sufficient to identify basic information about or attributes of the network resource. Such attributes may include, but is not limited to, (a) the name of the network resource, (b) its network location (preferably both in terms of physical location as well as address location, (c) the type of resource (e.g., the type of hardware—printer, scanner, user terminal, server, etc.), or the type of software—service object, process object, e-mail program, web browser, operating system, Microsoft Word, etc.), (d) a priority level for the resource, (e) an event specification reflecting its current and/or historical configuration files, log files, etc.

The database 204 may contain only active profiles 206 for resources that are currently in the network. Or, as an option, it may contain profiles for such current resources, as well as profiles for resources that are no longer in the network. These profiles for resources that are no longer in the network may be desirable for historical purposes, such as for modeling past structure of the network and understanding changes over time. To differentiate between current active resources and historical resources that are no longer in the network, a tag or coding on the profile may be set in the profile.

In a preferred embodiment, each profile 206 is stored as a separate document with the attribute data therein written in a descriptor language in searchable fields, and the documents are structured according to a standardized format allowing for easy access, reading, writing and searchability. The structure of using standardized fields facilitates the operation of the database manager and the user interface manager by allowing data to be stored and retrieved in accordance with a pre-set format. In a further preferred embodiment, the profile may be drafted in a standard descriptor language, such as the widely available XML language, to facilitate creation of standardized formats.

With respect to the service objects, the profile database 204 comprises a profile 206 for each of the service objects. In addition to the type of attribute data described above, the profile 206 for each service object includes at least (a) the location of the service object, and (b) a resource usage list comprising the identity of each network resource using the service object. The profile 206 may also contain one or more useage level attributes, such as the frequency of usage for the service object and/or a list indicating each time the object is used. The frequency of usage may be represented by keeping a list of each and every time the object is used (either for the life of the object, within a running period, e.g., within the last 60 days, or for within a predetermined number of uses, e.g., the last 100 uses), thus allowing the frequency to be determined by analyzing the times of usage. Or the frequency of usage may be calculated as each usage is detected, and updated by the database manager or the network monitor as a numerical value in a field of its own (a usage frequency field). In such a case, there is no need to keep a running list, and the stored time of usage may simply be the most recent usage.

As mentioned above, the location of the service object may include its network address of the object, which is important because that is how the other network resources interact with the service object, as well as the physical location of the object. Physical location may be important to the network administrators for purposes of understanding what network resources are located in certain geographic locations. For example, if the network administrator wanted to determine what resources the network would lose in the event of a power failure in a certain building, it may be beneficial to understand the network in terms of physical location as well as the network addressing used within the network.

A resource usage list contains an identifier (which may be by network address, name, profile address) for the network resources that use the service object. This information is beneficial because it tells what other resources are relying on the service object to function. Thus, if ten different process objects rely on the service object to complete their processes, this knowledge can enable the network administrator to tell what processes will be impacted in the event the service object fails or is no longer available. It can also tell the network administrator if the service object is over or underused in terms of the number of network resources, which may help the network administrator to reconfigure other network resources to use another copy of the service object.

Thus, the usage level of the service object, which is stored to its corresponding profile, may be (a) a calculated value representing the frequency of usage plus a time of last usage (and possibly a number of usages from which the value was derived, so that the difference between the detected usage and the most recent usage can be factored into the value on an appropriately weighed basis), or (b) a list of each and every (possibly within a predetermined backward looking period or for a predetermined number of occurrences) usage from which frequency can be easily derived. Knowing the last usage is beneficial because that information can be used to determine whether the service object has gone unused for a long period of time (which may mean it is obsolete and not worth maintaining). It is even more beneficial to maintain a list of the various specific times of usage, because that information can be used to determine times of usage for specific periods (for example, a certain object may not be used with great frequency over a month, but it may be used very heavily every Friday afternoon because of business factors), as opposed to just the amount of usage in general or the most recent use. Thus, when storing or analyzing usage level, that term encompasses data reflecting any of these types of information concerning usage.

As such, the network monitor 202, in whatever form it is implemented, will monitor the usage of each of the service objects in the network, and transmit the relevant data to profile database 204 by transmitting each usage of each object to the database 204. The database manager will accept that usage data for each service object, and modify the corresponding field in the object's profile 206 accordingly. Thus, where a list of usage times is maintained, the manager will write the time to the list. And when the frequency is maintained simply as an averaged value, that value may be modified based on the time period between the detected use and the most recent use, as mentioned above. The network monitor 202 will also transmit the identity of the network resource using the service object, and the database manager will modify the resource usage list as appropriate. If the resource is not on the list, the manager can write it to the list. And if it is already on the list, then the manager need not take any action. The details of this functionality will be discussed below.

In a further preferred embodiment, the data concerning what resources are using the service object, and the time when the service object has been used, may be integrated together. For example, the list of times when the service object has been used may also contain a field identifying the network resource that made the use. These fields may be regarded as the resource usage list, as they identify the network resources that are using the service object. In still a further preferred embodiment, where only a limited number of usages, or usages for a limited time period are maintained, maintaining the resource usage list in this manner may be beneficial, as it effectively deletes infrequent or outdated entries of network resources from the list. But for other purposes, it may be desirable to maintain a list of every network resource that has used the service object, as in some networks a very infrequent use may still be of high importance (e.g., production of annual reports for a business), and it would be undesirable to inadvertently eliminate certain infrequent resources from the profile. Thus, it is also possible within the scope of the invention to provide a field for each network resource in the resource usage list that identifies the time of last usage, and the database manager would update the time in that field when usage data is transmitted from the network monitor. This will enable the list of resources relying on the service object to be understood in the context of when those resources have been using the service object.

As noted above, loose connections denote a temporary connection between two network resources. In the context of a service object, the other network resources that directly call on the service object would be a direct loose connection. And the resources that have an indirect loose connection with the service object would be those resources that call upon the network resources that have a direct loose connection to the service object. The web of indirect loose connections in network can become quite large and complex as the network increases in size and complexity. Thus, the system may determine for each service object each direct loose connection or indirect loose connection between the service object and one or more network resources that use the service object; and store a type of loose connection for each network resource that uses the service object in the profile for the service object. The direct loose connections may be retained in a loose connection list. And the indirect loose connections may be retained in an indirect loose connection list.

These lists of loose connections may be used in addition to or in place of a resource usage list. This is because those network resources that directly use an object will also be directly loosely connected to the service object. But it may be beneficial to maintain a resource usage list that is separate because it identifies whether the object is using the resource or used by the resource. This dictates what upstream resources rely on the object, and will be effected by its failure or a delay in its operation.

The component of the network monitor for analyzing the profiles may determine the indirect loose connections between a service object and a network resource by analyzing (either directly or by interfacing with the database manager) the profiles in the profile database to identify a series of direct loose connections between the service object, the network resource, and at least one other network resource. That is, in analyzing a profile 206 for a given object, the system can determine the resources that have direct loose connections to the object. And then it can analyze the profiles of those resources to determine the resources that have a direct loose connection to those resources, thus determining the existence of indirect loose connections to the object. This can continue in a progressive manner, working upstream or outward from the object through each directly loosely connected resource, and then the first layer of indirectly loosely connected resources, and then through subsequent layers until all indirectly loosely connected resources have been identified for the object. This component of the network monitor may be distributed to the database manager, or be a separate and distinct component operating separately as part of the collective monitor.

As will be discussed in further detail below, the event specification of the profile 206 may contain the usage information (i.e., usage level, what resources used or were used by the resource, loose connections, relations, etc.). This information may be derived from reporting changes to the resource's log file, the process for which is discussed below. Thus, all this usage information may be derived from the data in the event specification. It is possible to format the event specification so that its fields also function to provide the resource usage list and other information discussed herein as being contained in the profile, and thus it may not be necessary (depending on the structure and format of the profile) to use separate fields for storing that usage related information.

With this data stored to the various profiles 206 on a continual basis via the network monitoring function and/or by analysis of the profiles to identify various connections and relations, a wide range of possibilities are available. Because the network monitoring is conducted automatically (and most, if not all of it, on a real time basis), the profiles contain a relatively current representation of how the service objects are being used in the network. This, in turn, allows the IT department and network administrators to make better decisions, cost-effectively allocate resources, and better inform the business they are supporting about network risks and capabilities.

For example, using the data stored in these profiles 206, reports can be generated by one or more report generators and the stored information can be reported via a user interface 208 for display in textual, graphical, or textual and graphical format. For example, the report could contain a list of network resources that call upon the service object, thus identifying to the network administrator what processes are supported by a given service object. Likewise, the report could give a graphical representation of times of use for the service object, thus allowing the network administrator to see how often and when the service object is used in an easy to understand visual format. If the loose connections are stored in the profile, a report may also be configured to list the direct loose connections, and possibly the indirect loose connections. Thus, a software program constituting a report generator may be configured to generate one or more types of reports. The report generator can automatically generate the reports on a scheduled basis or in response to an event, or may do so in response to a user request via a user interface. The report generator may couple to the database manager to gather and analyze the data used to generate its report(s), and likewise couple to the user interface for transmitting the report(s). The report generator functionality may be part of the network monitor, the database manager, or operates on its own. Likewise, its functions may be distributed to different components, including shared components with other functions (e.g., its analytical function may be performed by one components, while its report generation function may be performed by a separate component).

In one embodiment, the report generated by the report generator could be a failure analysis report for display in graphical, textual, or graphical and textual format. In a basic format, such a report could contain information indicating the network resources that use the given service object and that would be affected by its failure. Additionally, the report could contain usage levels (e.g., a frequency of usage) of the given service object by each network resource. Thus, in the situation where the profile correlates each network resource with its time of usage such that frequency can be determined on a resource by resource basis, this reporting allows the administrator to not only understand what resources are supported by the service object, but also what resources most heavily rely on the service object. For ease of use, usage level could be represented by a grading scale, such as a number scale (1-5 representing level of importance), or a color scale (e.g, red, yellow and green—as in red alert representing high levels of usage, yellow representing medium, and green representing low). Such a failure analysis capability can be invaluable in determining how the network and supported business will be impacted in the event a service object fails. And this enables such information to be predicted easily and in advance, allowing the network management to be conducted proactively.

Such a failure analysis report may be generated by the report generator on a basis of location, either by network address or physical location. In generating such a report, the report will indicate the one or more service objects at the given location, and the network resources that use the one or more service objects and that would be affected by failure of the given network location. In one example, the report may generate a page with all service objects at the selected location, and each object may have a selectable link that enables the user to pull up a page reporting the relevant information for that service object, including the network resources using the object and the usage level. This exemplary structure enables the user to move through and read the report on an object by object basis, much in the way one can select links in a webpage.

Because the profiles 206 are stored in a database 204, these reports may be generated by the report generator upon failure of an object or location (typically detected by the network monitor), and can be used to help reconstruct the objects, re-configure resources to use other objects, or otherwise address the loss of functionality caused by the failure. Since this data is stored in the profiles in their own database, the failure of the object or its location will not impact the ability to generate the reports providing this information. These reports may have any format, and the ones mentioned above are not intended to be limiting.

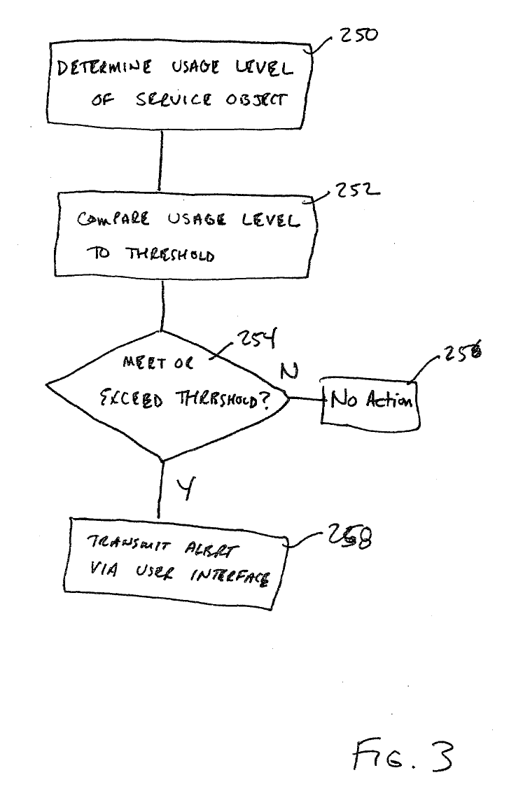

In a variation, the system may include one or more alert generators configured to transmit an alert via the user interface 208 if the usage level (e.g., the frequency of usage) of a given service object exceeds a predetermined threshold. An alert generator generates and transmits the alert. The alert generator may be part of the network monitor or a separate component, and may be in the form of a software program. It may be coupled to the database manager for gathering and analyzing data used to generate its alert, and likewise may couple to the user interface for transmitting its alerts. To this end, FIG. 3 depicts an alert process. The alert process determines the usage level for the service object (step 250), and compare that usage level to the predetermined threshold (step 252). The predetermined threshold may be data stored in a field of the profile 206, which may be denoted as a usage level threshold. Alternatively, the predetermined threshold by be set by a rule or set of rules in a separate rules database 210 coupled to the database 204, the network monitor, and/or the database manager. The use of rules in a separate rules database is advantageous because it allows the rules to be customized for each network or resource thereof, and the programming of the software making the determination does not need to be altered, as it receives the threshold from the rules database 210.

The decision control is shown at step 254. If the usage level does not meet or exceed the usage level, then no action is taken (step 256), and checking of other objects may continue. If the usage level does exceed the predetermined threshold, an alert may be sent via the user interface (step 258). This enables the network administrator to know when an object is being used heavily, and the network administrator may then consider whether to take corrective action. This allows the administrator to proactively monitor the network usage, and understand when an object is heavily used. This feature may be set to have a high priority report in the event the object experiences an extremely high usage, which could be an indication that the object is under a repetitive viral or hacking attack.

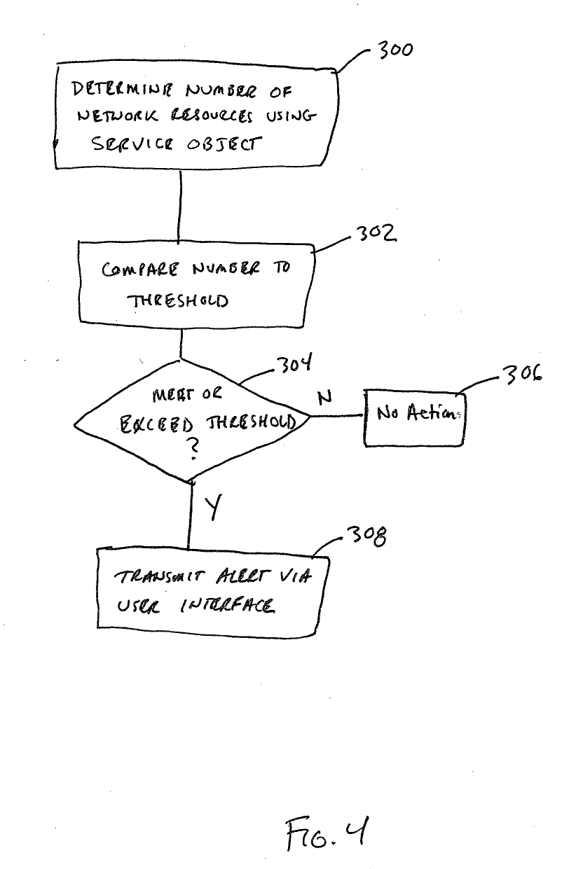

In another variation, the system may be configured to use the alert generator to generate and transmit an alert via the user interface 208 if the number of network resources of a given service object exceeds a predetermined threshold. Accordingly, FIG. 4 depicts an alert process in which the alert generator is configured to determine the number of resources using the service object (step 300), and compare that number to the predetermined threshold (step 302). The predetermined threshold may be data stored in a field of the profile 206, which may be denoted as a resource usage number threshold. Likewise, it may be defined by a rule or set of rules in a separate rules database 210, much for the same reasons described above. The decision control is shown at step 304. If the number of resources using the object does not meet or exceed the threshold, then no action is taken (step 306), and checking of other objects may continue. If the number does exceed the predetermined threshold, an alert may be sent via the user interface (step 308). This enables the network administrator to know when an object is being used by a large number of resources, indicating that a number of other resources are relying on that object for proper function. As with the usage level alert, the network administrator may then consider whether to take corrective action.

The alert may likewise be generated based on the number of network resources loosely connected to the service object (directly, or possibly even indirectly) if a number of loose connections for a given service object exceeds a predetermined threshold stored in the profile for the given service object. The number of direct loose connections and indirect loose connections could be analyzed together, or separately so that the direct loose connections are compared against a different threshold than the indirect loose connections (either threshold triggering the alert). Or the number of direct loose connections and the number of indirect loose connections could be weighted (i.e., multiplied by a value to reflect the weighting) and summed for comparison to a single threshold.

The functionality of generating these alerts may run “behind the scenes” in the sense that a dedicated software program constituting the alert generator may be used to continuously scan the profiles 206 in the database 204. This enables the program to check the objects on a continuing basis, and make the necessary comparisons and decisions. Because the data is stored in the profiles (e.g., the usage level is stored in a field, or can be derived from the list of usages, as noted above; the identity of each resource using the object is stored in the resource usage list; and the thresholds can be stored in their respective fields or in rules contained in a specification in the rules database 210), all these determinations can be made without interfering with operation of the network or using bandwidth in the network. Such a program may be referred to as an alert generator that is coupled to the database, and it may be configured to generate either or both of these types of alerts. The alert generator may be part of the database manager, or it may be independent, and it could operate on its own server or hardware coupled to the database 204 for access to the profiles 206. Likewise, its functions could be distributed (i.e., the analytical functionality for decision-making could be performed by one component while the alert generating and transmission functions could be performed by another component, including for example a component shared with other overlapping alert generators). In one alternative, the alert generator may include or call upon an inference engine or inference server for making these decisions using rules or knowledge in a database (such as a rules database) in accordance with an artificial intelligence methodology.

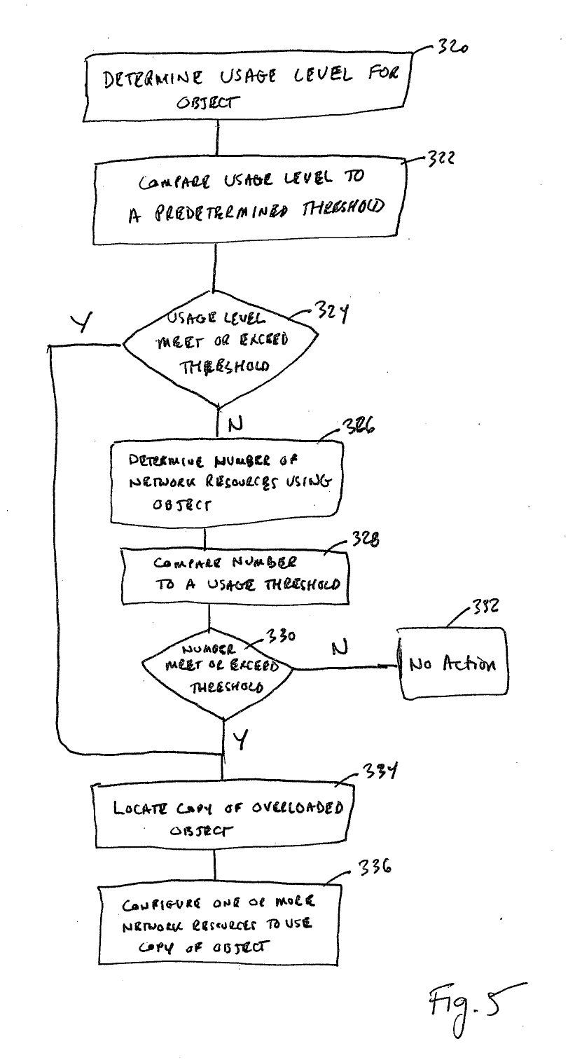

In yet another alternative, instead of generating alerts that simply give information on which the administrator can act, the system may also include one or more software or hardware components configured to take proactive steps to re-configure the network and its objects to maximize efficiency. For example, the system may include a component (such as a software program) be configured to identify an overloaded service object, and one or more components configured to act accordingly to locate a copy of that service object elsewhere in the network and re-configure certain resources using the overloaded object to use the copy. This load distributing function is illustrated in FIG. 5, and the network component(s) responsible for this process may be referred to generally as an overload re-distribution manager. The overloaded service object may be identified as an object meeting at least one of the criteria selected from the group consisting of (a) a usage level exceeding a predetermined usage level threshold or (b) a number of network resources using the service object exceeding a predetermined resource usage threshold. These criteria may be established as rules in the rules database 210 for each network resource, or type thereof; and the software program making this determination can use the associated rule from the rules database 210 to make this determination. Such a software program (i.e., the overload re-distribution manager) could be part of the network monitor, database manager, or could be a separate component operating on the same or a different server. Likewise, its functions could be distributed (i.e., the analytical decision-making could be performed by one component, the locating/creating functions by another component, and the re-configuring could be performed by yet another component). Such components may be shared with functions of other mechanisms or managers.

Thus, in step 320 the usage level for the object is determined, and in step 322 that level is compared to a predetermined usage threshold. This data may be derived from the same fields in a profile 206 or by a rule or rules in the rules database 210, as noted above for the alert functions. In step 324, if the usage level meets or exceeds the usage threshold, then the process proceeds to step 332, discussed below. If it does not, then the process proceeds to step 326. In step 326, the number of resources using the object is determined, and in step 328 that number is compared to a resource usage threshold. Again, this data may be derived from the fields in the profile 206 for the object, as was the case with the alert functions described above. If the number does not exceed the threshold, then the system determines no action needs to be taken (step 332), and the system may proceed on to the next object in its sequence. If the number does exceed the threshold, then the process proceeds to step 334.

In step 334, the object has been determined to be overloaded either by an excessive usage level, or an excessive number of resources using it. The overload re-distribution manager locates a copy of the overloaded service object. This is done by scanning the profiles 206 in the database 204 (either directly or through the database manager) for one or more other service objects that have the same name or descriptor in its profile 206 as the overloaded service object. Thus, each profile 206 should have a common descriptor for service objects that are the same. If no copy is found, the overload re-distribution manager may proceed to transmit an alert to the user interface, similarly to the alert function described above. This would enable the administrator to authorize a copy to be made, and to obtain any necessary licensing permissions. Or, alternatively, the system may be configured to automatically create a copy of the service object (and possibly transmit data to a license maintenance database or list so that proper license fees can be paid if the object is a third party program requiring a license fee). The determination whether to make the copy, transmit data concerning a license, or to send an alert to the user interface may also be governed by a rule or rules in the rules database 210, and these rules may vary between different service objects.

Assuming that a copy is found or created, one or more of the network resources using the overloaded service object would then be configured (e.g., by modifying its configuration file) by the overload re-distribution manager to use the copy of the overloaded service object. Various rules may be created to determine how the resources should be allocated among the original overloaded object and the copy or copies. For example, the system may count the number of resources or sum the usage levels for the overloaded object and the one or more copies, and apportion the network resources to use the overloaded service object and the copy or copies in an equitable manner. For example, the rules may dictate that the usage levels are summed, and average is determined, and the resources are assigned in combinations so that each object should experience a usage level as close to the average as possible (e.g., if an overloaded service object has a usage level of 50, and two other objects each have usage level of 25, the distribution may be 34 for one service object, and 33 to each of the other two). Likewise, the number of resources using the object and the copy(ies) may likewise be summed and averaged so that the resources are distributed as close to an average as possible. Any suitable rules for apportioning the resources may be used (e.g., if a service object is used by 10 resources, and two copies are used by 2 each, the distribution may be 4 for one object, and 5 each for the other two).

These rules could be set in a specification in the rules database, and may vary for different types of objects. For example, the rules may provide a preference that resources use closer geographical objects to reduce load on long-distance network pipelines and bandwidth. Likewise, rules may set a preference that a certain important process use an object with a low maximum usage level to ensure the stability of the process. Various rules may be crafted and maintained in the rules database. As mentioned above, the advantage of this is that the programming for implementing this functionality may generally left unaltered, and the rules in the database can be altered and customized to meet evolving network needs.

To re-configure the resources, the overload re-distribution manager may actively alter the resource program (e.g., the software itself if it is a software object, or driver software if it is a hardware object) by changing the network address used to call on the overloaded service object so that it calls on the copy (this information typically resides in the resource's configuration file, which is modified to effect this change). Basically, the system can automatically update the network addresses used by the network resources to ensure that they are distributed among the service objects to ensure a more efficient distribution of workload. The system may also update the profiles 206 in the profile database 204 for the service objects, the copy or copies, and the network resources themselves so that the profiles now accurately reflect the change in usage. For the object and its copies, this is done by adding the newly assigned network resources to the resource usage list in the profile 206 for each object, and deleting the network resources that no longer use the object or its copy(ies) from the appropriate resource usage list. This gives the database a real time reflection of the re-distributed usage assignments.

Updating the configuration file of a resource may take place in any known manner, and need not be described herein in detail. Suitable programs for updating the configuration file, or creating a new one and transmitting it to the resource, may be used.

These locating and configuring acts may occur automatically without user intervention, or as mentioned above may include user approvals before implementing the changes. The ability to perform all these functions automatically is advantageous because it allows the system to efficiently and pro-actively manage network loading without requiring user intervention, leading to more effective overall network with a better use of its capacity and/or bandwidth.

This load distributing function (i.e., the re-assignment of usage of an overloaded service object) may be performed by a dedicated program running on the database manager, or it may be integrated into the software running on the database manager. Likewise, it may be a software program that runs on a separate dedicated server that couples to the database 204 so that it has direct access to the profiles 206. Or it may be coupled to the database manager so that the database manager can manage the workflow of programs accessing the database 204. It may also be combined with the alert functionality described above. It may also be governed by an artificial intelligence methodology using an inference engine/server and a knowledge database (such as one comprised of rules, including semantic rules or other representations of knowledge).

The determination of whether an object is overloaded may also be made on the basis of the number of loose connections for the object as compared to a predetermined threshold, if such a list of loose connections is maintained in the profile. In that case, the re-configuration of network resources would be done to those that are directly loosely connected to the overloaded object. And the modifications (i.e., additions and deletions) would take place relative to the profiles of those re-configured directly loosely connected resources.

This copy-creation and load distributing capability may also be used or modified to re-distribute network tasks to service objects in the event a service object fails. The procedure is essentially the same as described above for load distributing, but occurs in response to detecting a failure of a service object. This failure may be detected by the network monitor, and failure may be reported as an agent message as described below. Thus, if a given service object fails, the method comprises: detecting the failure of the failed service object; locating or creating a copy of the failed service object; and configuring the network resources identified in the stored information as using the failed service object to use the copy of the failed service object. The locating/creating, detecting and configuring acts would occur in the same manner as described above for the load distributing function, and may include the allocation functionality described above for assigning workload among multiple copies. These acts may occur automatically without user intervention.

Likewise, this failure recovery feature can be implemented on a network location basis. Thus, if a given network location fails, the method comprises for each service object at the failed network location: locating or creating a copy of the service object; and configuring the network resources identified in the stored information as using the service object to use the copy of the service object. The process is the same for an individual service object, but the recovery would be done for each and every object at the location (to the extent possible).

If failure recovery of an object is not possible, i.e. a copy cannot be found and cannot made because of license restrictions, an appropriate alert can be transmitted to the user interface 208.

As with the other capabilities, this failure recovery capability can be built into the database manager or network monitor, or it may be a separate program operating on the same server, or on a separate server, or its individual functions may be distributed among different components. The component(s) of the system performing this function may generally be referred to as a failure recovery manager, and it may be part of or share overlapping functions with the overload re-distribution manager.

Likewise, this failure recovery capability could be conducted on the basis of the direct loose connections stored in the profile 206 for the failed service object. As such, the one or more network resources identified the profile as directly loosely connected to the failed service object would be re-configured to use the copy of the failed service object. And the profile for the given service object would be modified to delete the one or more network resources from the list of direct loose connections, and the profile for the copy of the given service object would be modified to include the one or more network resources each as a direct loose connection.

With this failure recovery, it is also possible to leave the network resource or loose connection list for the failed object intact, and flag the service object as failed so that it is not used. Then, after recovery, this information can be analyzed, thus allowing the system to re-configure the network resources that were transferred over to a copy to again use the failed, but now restored, service object. And likewise, the profiles for those network resources and any copy could be restored to delete the additions that occurred during the failure recovery. This may be implemented automatically, or triggered manually. The advantage is that this prevents short temporary failures from causing an inadvertent long term re-distribution of loading to other service objects, and allows restoration of the network back to its original condition.

Alternatively, the failure of the service object may simply result in the failure recovery manager sending an alert to via the user interface indicating the failure of the service object. Preferably, this alert will identify each network resource using the service object based on the stored information in the profile. The software generating the alert will analyze the profiles in the database to identify those resources as part of its response to the failure. This information may be derived from the resource usage list in the profile, or from lists of direct and possibly indirect loose connections. Such information in addition to the alert itself can allow the network administrator to readily understand what capabilities in the network will be effected by the object failure.

As another alternative feature, the profiles 206 in the database can be analyzed to identify one or more critical service objects. This critical service object analysis may be performed by software that is part of the database manager or network monitor, or it may be a separate program running on the same or a separate server. Likewise, its functions may be distributed among different components. Such software may generally be referred to as a critical service object manager. These are service objects that meet one or more of certain criteria, which are indicative of the service object being important to the functioning of the network or the supported business. The criteria may vary from business to business and network to network. For example, a critical service object may be a service object meeting at least one of the criteria selected from the group consisting of: (a) a usage level exceeding a predetermined usage frequency threshold, (b) a number of network resources using the service object exceeding a predetermined resource usage threshold, (c) a prioritization level, and (d) a time of when the object was used being within a predetermined period. These factors may be determined by using a rule or rules stored in the rules database 210, thus allowing the factors to be altered as desired.

Factor (a) indicates that the object is heavily used, and thus it may be important to the network or the business. Factor (b) likewise indicates that the object is called on by a larger number of resources, indicating that many resources rely on it. Factor (c) is a rule, tag or value that is pre-set in the profile 206, and detecting of that value, tag or rule would indicate that the object is critical irrespective of other factors. Or it may be derived from a rule or rules set in the rules database 210. For example, the network administrator may know that a certain object is infrequently used by few resources, but is deemed critical anyways, and therefore a prioritization level may be set to indicate as such. Prioritization level may also be based on the name, type or other descriptor, and the program may know the priority level from that information rather than having a separate priority field. Factor (d) is useful to indicate objects that may not meet any of these criteria, but the object may be used at a critical time in the business. For example, certain financial functions may be run on a daily basis between certain hours, and the network may wish to flag all objects running at that time as being critical to supporting that function. The criteria may also be blended. For example, each criteria could be weighted into a formula or algorithm that determines whether the object is critical or not (e.g., moderate usage by a moderate number of resources on an object having a medium priority level may still qualify as critical, or whereas high usage by few resources on an object having a low priority level may not be deemed critical).

Likewise, if loose connections are stored in the profile 206 for an object, the determination of whether an object is a critical service object may be made on the basis of analyzing the loose connections stored in the profile 206. For example, if the number of total loose connections exceeds a predetermined threshold, the object may be deemed critical. Alternatively, direct and indirect loose connections may be analyzed separately and compared to separate thresholds. Or the number for each may be weighted (i.e., multiplied by a value) and summed for comparison to a single threshold. In such a weighted comparison, the direct loose connections may be accorded more weight than an indirect loose connection.

The user may initiate a program (i.e., the critical service object manager) to scan the profiles 206 in the database 204 to make these determination, and report the data via the user interface 208 to identify the one or more critical service objects. Such a report may be coupled with the types of failure analysis report discussed above, thereby enabling the network administrator to not only see the critical service objects, but also to see the resources that use those objects (and possibly how often). Such data may likewise be expressed in terms of direct loose connection and possibly indirect loose connections. The report may also include the levels of the factors that triggered the determination that the service object is a critical service object.

Alternatively, the process for determining critical service objects could be run automatically by the critical service object manager. For example, the program managing the process could generate this report on a periodic basis (e.g., weekly, bi-weekly, monthly, etc.). With this report, the network administrator can make an informed decision about management of the network. For example, by knowing which objects are deemed critical by the report, the administrator can decide how to allocate network maintenance resources, back-ups, failovers procedures, and bandwidth construction with an eye towards better support for those critical objects. Such information can also be used in the event of there is a failure in the network to assist the IT team in prioritizing its response so that resources are dedicated to restoring operation to critical objects first.

It is also advantageous to understand the relations between various components in the network, as in the direct and indirect relations defined above. Thus, the method may further comprise, for each service object, determining with the critical service object manager each direct relation or indirect relation between the service object and one or more network resources on which the service object operates. This may be done by the network monitoring, or at installation of the service object. And this information can be determined from the configuration file of the service object that enables the object to run on the resource(s) to which it is related. These relations may be distinguished between direct and indirect relations to enable the difference between the relations to be understood. This information, like other information, is stored in the profile 206 for the service object in a resource relation list. The list may contain fields indicating a type of relation in the relation resource list, or the type of relation may be differentiated by using separate lists for indirect and direct relations in the profile 206.

Because indirect relations may not be readily apparent from the configuration of a service object, the indirect relation between a service object and a network resource may be determined by analyzing the profiles in the profile database to identify a series of direct relations between the service object, the network resource, and at least one other network resource. This is similar to the manner in which the indirect loose connections are analyzed, as discussed above, where the analysis progresses “outwardly” or “radially” through the sets of direct relations to identify the indirect relations.

With this knowledge of indirect relations, the reporting function for critical service objects as described above may be enhanced by additionally identifying the one or more network resources with which each of the one or more critical service objects is directly or indirectly related. Again, this information would be derived by analyzing the profiles 206.

Likewise, the failover capability may be enhanced with this knowledge in the profiles 206 of relations between a service object and any network resources. As such, if a given network resource fails, the method executed by the failover recovery manager may further comprise: detecting the failure of the failed network resource; locating or creating a copy of one or more of the service objects directly or indirectly related to the failed network resource; and configuring the one or more network resources identified in the profile as directly loosely connected to each of the one or more of the service objects to use the copy of the each of the one or more service objects. Because this knowledge of direct and indirect relations in the profiles 206 for any service objects with respect a resource, the profiles 206 can be analyzed to find any objects related to a failed resource, and re-task resources that use those objects in this failure recovery capability. These may occur without manual intervention.

With respect to process objects, many of the discovery tools described above can be implemented to provide the same management and discovery of process objects. Thus, the invention also includes a method for managing usage of process objects in a network comprising network resources including service objects and the process objects. As mentioned above, each service object is configured to performed a specified function and further is configured to be used by other network resources including the process objects. Each process object comprises executable code for using one or more of the service objects. A process object typically runs on a specialized server called a workflow manager, which is designed for scheduling and management of tasks. The method generally comprises:

i. monitoring a usage of each process object to determine at least (a) a usage level for the process object, (b) an identity of each network resource using the process object, and (c) an identity of each service object used by the process object; and

ii. storing the information determined by said monitoring, the information including for each process object at least (a) the usage level for the process object, (b) the identity of each network resource using the process object, and (c) the identity of each service object used by the process object.

The method is best achieved when coupled with the management and discovery of service objects, as described above. Knowledge of the service objects better allows for an understanding of performance and stability of the process objects, as process objects rely on service objects to complete specific functions and tasks.

Preferably, the information stored for each process object also includes a location of the process object on the network. As with the service objects, this location may be expressed in terms of network address (which is how the network communicates between objects and resources), as well as in terms of geographic location. An understanding of both types of location provides a better understanding of the interconnections (both physical and functional) within the network.

All the reporting functionality described above with respect to service objects may also be provided for process objects. Thus, anything described above relative to service objects may also be treated as applying equally to process objects. In addition, because in a hierarchical sense process objects are above service objects, such a report may be designed so that a list of service objects on which the process object relies may be viewed. And the report could be coupled to individual reports of the type described above for service objects, such that the report for each individual service object could be accessed through the report for the process object, such as by a hyperlink to the associated service object report.

The profile 206 for a process object would be configured similarly to that described above for a service object, and thus the discussion above for service objects applies equally here. In addition, because process objects use service objects, a separate list of service objects (or other resources) used by the process object may be maintained in a use list, just as a resource usage list may identify all resources (or human users) using the process object.

The same functionality and analysis for populating the resource usage list, resource use list, and any lists of direct or indirect loose connections in the profiles of the process objects may be the same as used for populating the service objects, as described above. Such data may be transmitted from the network monitor, and likewise may also be populated by analyzing the various profiles in the database to determine the various connections and relations within the network.

The same alert functions described above for service objects may also be implemented the same with respect to process objects. Such alerts may also include an identification of network resources that use the process object, so as to provide a complete understanding of the effect that may be caused. As described above with respect to service objects, such alerts may be based on the usage level exceeding a threshold, a number of resources using the process object exceeding a threshold, connections exceeding a threshold, or failure of the process object. These functions would preferably be performed by the same software performing those functions for the service objects. As an additional layer of knowledge, the alert function may also be based on knowledge of what service objects are used by the process object, based on the loose connections or the resource use list in the profile 206 for the process object. Thus, the alert transmitted via a user interface may be sent in relation to the process object if it is determined that a service object used by the process object has a usage level or number of resources exceeding an associated predetermined threshold. This alert may be the same type of alert described above for this purpose with respect to a service object, but can additionally report the one or more process objects using that service object. This provides a more complete understanding of the impact that excessive loading of the process object or an underlying service object may cause.

Likewise, the same failure analysis reporting capability described above for service objects may be applied equally to process objects, and implemented in the same manner described above. As with service objects, the failure analysis report for a process object may include information indicating the network resources that use the given process object and that would be affected by its failure. Likewise, the report may also indicate the usage level for each network resource on the process object. Further, as was the case with the service objects, the failure analysis report could be prepared on the basis of a network location (e.g., either a physical location, such as to analyze the effect of a power outage or connectivity loss with a certain physical location, for example a building housing a number of servers; or a network location, such as to analyze the effect of a failure of a specific location, for example a server running various processes). Such a report on a location basis may also be combined with the same type of report that analyzes the effect to the service objects at that location.

Likewise, in the same manner as described above with respect to service objects, the system can be used to identify one or more critical process objects based on certain criteria. Preferably, the same program used to make this determination for service objects can make the same determination for process objects, using the same criteria as described above. Thus, a critical process object may be a process object meeting at least one of the criteria selected from the group consisting of (a) a usage exceeding a predetermined usage frequency threshold (b) a number of network resources using the process object exceeding a predetermined resource usage threshold, (c) a prioritization level, and (d) a time when the process object was last used. These factors were discussed above with respect to service objects, and that discussion applies equally here. The critical process objects may be report via a user interface in the same manner described above for service objects, and preferably the report would compile service and process objects for providing a more complete understanding of the critical components in the network.

As was the case with service objects, when engaging in any comparative or decision-making analysis, the analysis may be made against or governed by a rule or rules in the rules database 210. Moreover, an artificial intelligence methodology supported by an inference engine/server that analyses rules or knowledge in the database (e.g., semantic rules or other representations of knowledge) and makes conclusions may also be used to perform any analytical or comparative functionality described herein. Thus, generally speaking, any of the comparative, analytical or decision-making functions discussed herein may be performed by the database manager, network monitor or other component responsible for the determination submitting at least one query to an inference engine or server, which in turn consults a rules or other knowledge database to formulate a conclusion. Thus, instead of having all the logic supporting the decision/comparison/analysis in the scripted into the database manager, network manager or other program, it can submit a query to the inference engine or server, which will then seek relevant rules or knowledge from the rules or knowledge database (which is typically in schematic form). The rules/knowledge may inform the inference engine/server that further facts/data are needed from the profiles in the database, and the inference engine can request those facts/data from the database manager. This may be repeated until the inference engine/server is able to render a conclusion based on the data in the profiles and the applicable rules/knowledge in the knowledge or rules database. One advantage of this approach is that the rules/knowledge can be updated or revised without altering the database manager or inference engine/server.

Next will be described a specific, non-limiting methodology for gathering the information used to update the profiles 206 in the profile database 204, and a methodology for deploying and/or undeploying agents to the network for actively gathering such information. These agents and their management/deployment may be used in any type of network architecture, including SOA or otherwise.

There are generally two types of agents used in a network: active and passive. Active agents are populated within the network and assigned to a resource. An active agent is configured to (a) actively check the resource for any changes in the data the agent is configured to monitor, which may be the resource's configuration file, or a log or transaction file containing a record of errors that have occurred with the resource, or transactions concerning the resource, and (b) report any such changes on its volition. Such a log or transaction file may contain a record of which resources have used the subject resource, or the resources that are called upon (i.e., used by) the subject resource, and may also keep a record of when those uses have occurred. This data can be used to populate the resource profiles 206 with information such as the resource usage list, the resource use list, the usage level, connections, relations, etc., as discussed above. Likewise, the active agent may monitor a current status of the resource (such as whether it is in operation). A “passive” agent is an agent that is not assigned to and actively monitoring/reporting on a resource, but rather is sent remotely through the network to check for the same such information. This is often referred to as scanning. Because a passive agent is not actively associated with a network resource and reporting on an ongoing basis, the problem with such monitoring is that the reported data may change between checks. Thus, the reported data is only as reliable as the frequency of the checks. However, scanning takes up network bandwidth, and thus increasing scanning frequency introduces its own problems.

These active and passive agents are at times also referred to as permanent or temporary, respectively. This is because the active agent remains assigned to its resource and continually performs its monitoring and reporting functions on its own; whereas a passive agent is sent out temporarily by a scanning operation to perform its monitoring and reporting function. A passive agent may also be an agent that is deployed to a resource, but does not perform an on-going reporting function and merely waits to be activated by a command sent out by scanning to issue a report.

Thus, in an aspect of the invention, there is proposed a method and agent manager for deploying active data reporting agents to network resources in the network in an intelligent manner so that active data reporting agents are deployed to resources where they are needed the most.

In the system, each active data reporting agent comprises executable code and is configured to cause transmission of data relating to an associated network resource to a data monitor. The data monitor may be the network monitor 202, or it may have any other configuration or architecture. In one example, the network monitor 202 may handle the functions of receiving data from the agents and transmitting the same to the profile database, performing the above described analyses of the database to understand the status of the network and manage objects, and the assignment of agents. In another example, the device for assigning active reporting agents may be integrated into the network monitor, it may be separate from the monitor, and may run on its own dedicated server, or it may be an object that runs on the same server as the program performing the network monitoring. The hardware device and/or software program responsible for assigning active agents to network resources may be referred to as an agent manager. An agent may be regarded as a resource within the network 200, and preferably active agents installed in the network 200 have their own profiles 206 in the database 204. As will be described later in the application, the network monitor 202 (or a component thereof) is configured to monitor the status of the network resources by (a) receiving the data transmitted from the active data reporting agents, and (b) remotely scanning the network resources without active data reporting agents to retrieve data from the scanned network resources. As mentioned above, this remote scanning may be done with passive agents, such as those that are sent out into the network and transmit data back to the monitor, but are not installed permanently.

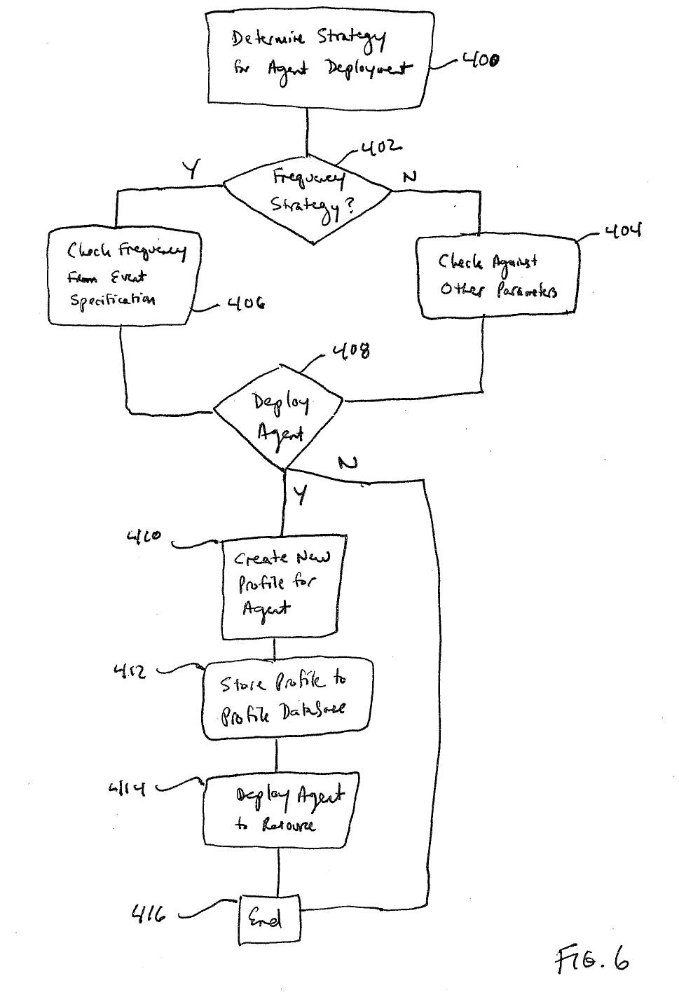

In the agent deployment process, shown in FIG. 6, a frequency of changes in the retrieved data is determined for a plurality of the scanned network resources (i.e., those not using an active data reporting agent). As mentioned above, typically this data will relate to the resource's configuration file, transaction or log file, etc. The data may be the actual raw data being examined on the resource (for example, a fall copy of the configuration file), or it may be in a more compact or abbreviated format. The agent manager may include executable code for performing this determination, which may be referred to as a frequency change determination component.

In FIG. 6, the agent deployment process performed by the agent manager includes determining a strategy check 400 for agent deployment. This may be performed by a strategy determination component, which may be in the form of executable code. The strategy will typically be dictated by rules set forth in one or more rules contained in the rules database 210, or it may be dictated by a tag contained in the profile 206 for the resource being evaluated. In the rules database, such a rule or rules may be maintained in a document called a deploy specification, which may be a document written in a descriptor language such as XML. By comparing the profile 206 to the rule or rule, the type of deployment strategy may be determined.

The process performed by the agent manager's strategy determination component checks whether the deployment is to be governed by the frequency in data changes, or whether it is governed by one or more other parameters. This is shown at 402. Other parameters that may govern the deployment of an active agent may include the priority level of the resource, an override set by the network administrator, or some other parameter relating to the resource which may be used to govern deployment of an active agent. If the deployment strategy is to be governed by a parameter other than data change frequency, the process may proceed to 404 to check the profile 206 for the resource against the one or more other parameters. For example, where a prioritization level for the network resource is detected, and the network resource has a predetermined prioritization level: (a) an active data reporting agent is assigned to the network resource and (b) the data monitor is configured to not scan the network resource. This prioritization level determination may be performed by a prioritization level detection component of the agent manager, which may be constituted by executable code.

If it is determined to use a frequency check, then the process proceeds to 406. Generally, for any scanned network resource determined by the frequency change detection component to have a data change frequency above a first predetermined threshold: (a) an active data reporting agent is assigned to the network resource and (b) the data monitor 202 is configured to not scan that network resource. The agent manager may be coupled to the profile database to enable the frequency change detection component thereof to analyze the profile and/or their event specifications. Thus, in conducting the frequency check, the method may examine the event specification contained in the resource's profile 206. An event specification maintains a record of the changes in the relevant data being monitored. For example, if the configuration file for the resource is being monitored, the event specification would contain a record of various changes to the configuration file. Likewise, if the log file for the resource is being monitored, the event specification may contain a record of various changes to the log file. Preferably, these records are kept for a set period of time (e.g., 1 week, 1 month, etc.), and by examining the event specification the method can determine the frequency of the changes in the examined data. A rule or rules from the deployment specification of the rules database will dictate the threshold for comparison, and if the change frequency meets or exceeds that threshold, a decision to deploy an active agent is made. This is beneficial because this means that the system will be assigning an active agent to a resource that experiences frequent changes, and therefore active reporting of those changes will provide a more current understanding of the status or configuration of the resource. The component of the agent manager that assigns/deploys the active data reporting agents to the resources and configured the data monitor not to scan those resources may be referred to as the agent assignment component, which may be constituted by executable code.

As an additional or alternative feature, for any scanned network resource determined by the frequency change detection component to have a data change frequency below a second predetermined threshold, the first threshold being greater than the second threshold: (a) the active data reporting agent is assigned to the network resource and (b) the data monitor is configured to not scan the network resource (also performed by the agent assignment component). This second threshold may likewise be set by the deployment specification from the rules database 210. This functionality is beneficial from a network bandwidth efficiency standpoint. If it is determined that a resource rarely or never changes, and thus has a data change frequency below this second threshold, then there may be little benefit in periodically scanning that resource for changes. In a network with numerous stable, unchanging resources, scanning them occupies bandwidth, but there will be few or no changes to report for those stable resources. As such, assigning active agents to them will allow the scanning process to focus on resources that are more likely to have changes (but not so many as to warrant the assignment of an active data reporting agent), and thus make its occupancy of network bandwidth more efficient.

The decision block as to whether to deploy an agent is shown at 408. This decision is derived from either the frequency check at 406, or the use of some other parameter in 404. Alternatively, the program making this determination could be configured to make a hybrid determination based on both frequency and at least one other factor. For example, the frequency could be weighted in an algorithm along with prioritization level or some other parameter. Thus, a high priority resource with a lower data change frequency may have an agent deployed, whereas a lower priority resource with the same data change frequency may not.

If an agent is to be deployed, the system creates a new profile 206 for the agent (block 410), and stores that profile 206 to the profile database 204 (block 412). This may be done by a component of the agent manager, or it may call on functionality in the database manager. Then, in block 414, the agent is deployed to the network by the agent assignment component of the agent manager. This is done by transmitting the agent to an appropriate location and installing it on the hardware on which it is designed to operated. The agent can be installed on the hardware associated with the resource it is configured to monitor (or on the resource itself is the resource is hardware). Or it can be installed on a separate server or other hardware item, and may be configured to monitor the target resource on a frequent and loosely connected basis. The means for deployment of an agent over the network is known and need not be detailed herein.

When the agent is deployed, it is no longer necessary to remotely scan the resource with the data monitor 202. As such, the data monitor 202 may be configured to no longer scan that resource. That configuration may be done directly to the monitor 202 itself (e.g., by having the agent assignment component transmit an appropriate instruction script), or it may be done indirectly by updating the profile 206 in the profile database 204 for that resource. Updating the profile 206 would be used where the monitor 202 does not maintain a dedicated configuration file dictating which resources should be remotely scanned, and instead scans the profiles 206 to determine whether a scan should be conducted for the associated resources (e.g., it looks at each profile for a tag or other indication as to whether the resource should be scanned, or whether it already has an active agent assigned to it). Thus, the term configuring the monitor 202 may cover either of these alternative.

After deployment of the agent to the resource, the process ends at block 416. Likewise, if in block 408 it was determined that no agent should be deployed, the process also proceeds to the end at block 416. The process may then be repeated for each and every resource registered in the profile database 204. For each resource examined, the process may initially check whether the resource already has an active agent associated with it, and if it does not it may proceed with the methodology described above. This process may be ran with any level of frequency.

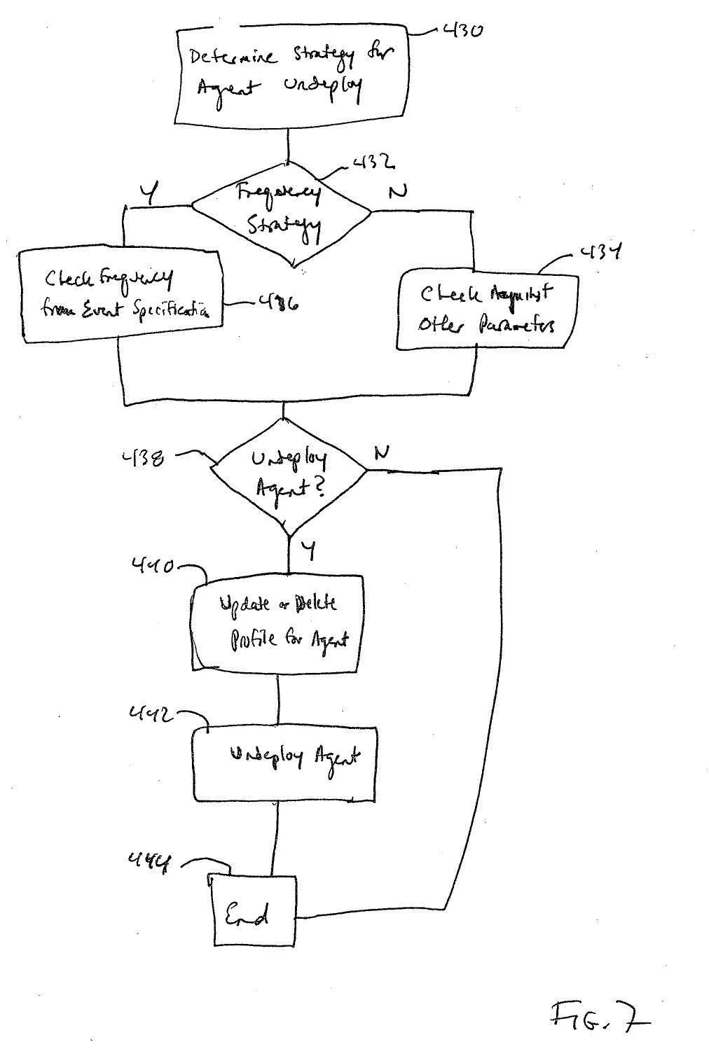

As an additional or alternative feature, the system may also include functionality for undeploying agents from network resources where they are no longer needed. The component of the agent manager responsible for this may be referred to as an agent undeployment component, which may also be constituted by executable code. The methodology is similar to that for deploying agents, and may be run at the same time as the deployment operation. For example, if the system determines that a resource has an active agent assigned to it, instead of moving on to the next resource, the method may implement this methodology to determine whether the agent should be undeployed. FIG. 7 depicts the agent undeployment process.

In block 430, the method determines which type strategy should be used for deciding whether to undeploy the agent. This is essentially the same as block 400 in the process shown in FIG. 6.

Following the decision block 432, the method either proceeds to using other parameters besides frequency (block 434) or to the use of a frequency check (block 436) for making the decision as to whether to undeploy an agent. The analyses conducted in blocks 434 and 436 is essentially the same as made in blocks 404 and 406 in FIG. 6, except that the analyses are governed by parameters that dictate whether an active agent should be undeployed, rather whether an active agent should be deployed. For example, if a frequency check is used, the agent us undeployed if the frequency us below a predetermined undeployment threshold (such as the same threshold above which an active data reporting agent is deployed, or between the two above and below which an agent is deployed).

In block 438, the decision is implemented as to whether the agent should be undeployed. If the answer is no, then the process proceeds to the end at 444. If the answer is affirmative, then the process proceeds to block 440. At block 440, the profile 206 for the agent being undeployed may be deleted from the profile database 204, thus reflecting that it is no longer present as a resource in the network. Or it may be updated so as to reflect that it has been removed from the network, with the profile being retained as a historical record rather than a profile of an active installed resource. This may be registered by a tag on the profile that indicates it is for a resource that was installed, but is now no longer present in the network. Instead of being outright deleted, the agent may also be deactivated, and likewise its profile may be updated to denote its deactivated status.

In step 442, the agent is undeployed (i.e., deactivated, deleted, or uninstalled) from the network. The means for undeployment of an agent from the network is known and need not be detailed herein. After undeployment or deactivation of the agent, the process ends at block 444. The method may them be repeated for each and every resource registered in the profile database 206 alone or in conjunction with the deployment methodology described above.

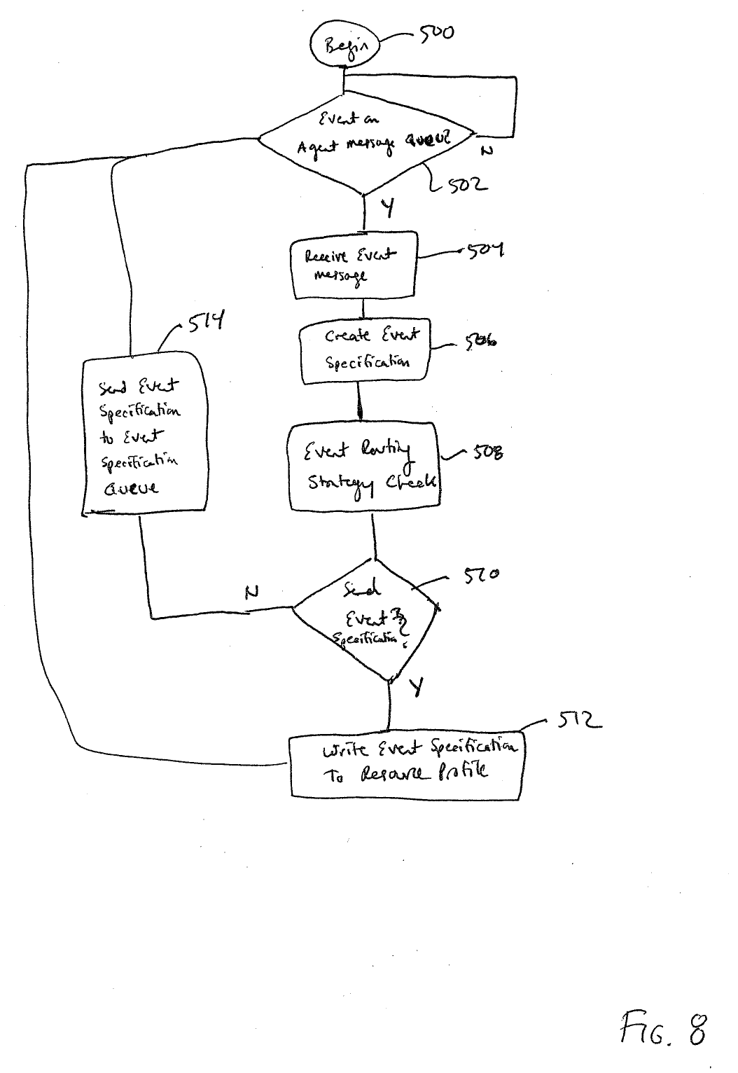

FIG. 8 illustrates agent message management process, which is part of the process that receives information about data changes from the agents or scanning. The agent message management process may be managed by a software program (i.e., executable code) referred to as an agent message traffic manager which manages the message traffic. Thus, the data received may be from an active agent, or it may be from an agent sent out for remote scanning, as discussed above. The data will reflect a change in the data being examined, such as attributes, the configuration file, the log file, etc. The data sent by the agent is referred to as an agent message, and these messages are sent to an agent message queue, which is part of the network/data monitor 202.

The agent message may be crafted in XML or some other descriptor language. And the message may be formatted in an abbreviated format to indicate the type and nature of the change, without reporting the entire file being examined. For example, if there is a change to the log file, the message may contain data that only includes the new change, but does not send the entire file. Likewise, if the change is to the configuration file, the message may contain the specific change and the aspect of the file to which it relates, rather than reporting the entire file.

The process begins at 500, and in block 502 determines whether an agent message is present in the agent message queue. If there is none, the process will loop back and continue checking. When a message is detected in the agent message queue, the message is received by a module responsible for creating an event specification, referred to as an event specification creator that is coupled to the agent message queue, and may be constituted by executable code. This may be part of the network monitor, or it may be a separate object that is responsible for this functionality. When the agent message is received by this module in block 504, the event specification creator then creates an event specification based on the message (block 506). The event specification is a record that is typically crafted in the same descriptor language as the profiles 206, and is formatted to be stored in the profile 206 for the associated network resource. The event specification contain the same data as the agent message, and simply be a reformatting of that data for recording to the profile. Or the agent message may be an abbreviated message, which is converted into a more detailed data format as the event specification. The event specification creator may be part of the agent message traffic manager.

The process then proceeds to a strategy check in block 508 to determine whether to send the event specification immediately to the associated profile 206 in the profile database 204, or whether it can be delayed. The component performing this act may be referred to as an event specification router, which is coupled to the event specification creator, and may be constituted by executable code. This is governed by an event specification routing strategy that may include one or more priority rules that may be embedded in the program, or that may reside in a specification contained in the rules database. Typically, the governing parameter will be the prioritization level of the associated resource, or the prioritization of the type of change represented by the message. For example, if the change is to the configuration file of the resource, that may be regarded with a higher priority than a change to the log file. In decision block 510, if the event specification is to be sent, the process proceeds to block 512; and if it can be delayed it is sent to block 514.

In block 512, the event specification is sent to the database 204 so that it can be stored to the profile 206 for the associated network resource. This may be handled by the database manager for the database, or this updating/writing functionality may be integrated into the monitor 202. Either way of managing this is acceptable. With the event specification immediately written to the profile 206, the profile 206 contains a relatively current representation of its status.

In block 514, the event specification is not immediately sent to the database 204, then it will be routed to an event specification queue coupled to the event specification router and/or creator. This event specification queue is designed to temporarily store lower priority event specifications, and these will be updated to the profiles 206 in the database 204 in due course. The use of this differentiation between types of event specifications based on priority enables higher priority changes in the network to be updated to the database 206 more quickly, thus enabling the database 206 to be more current in terms of high priority issues.

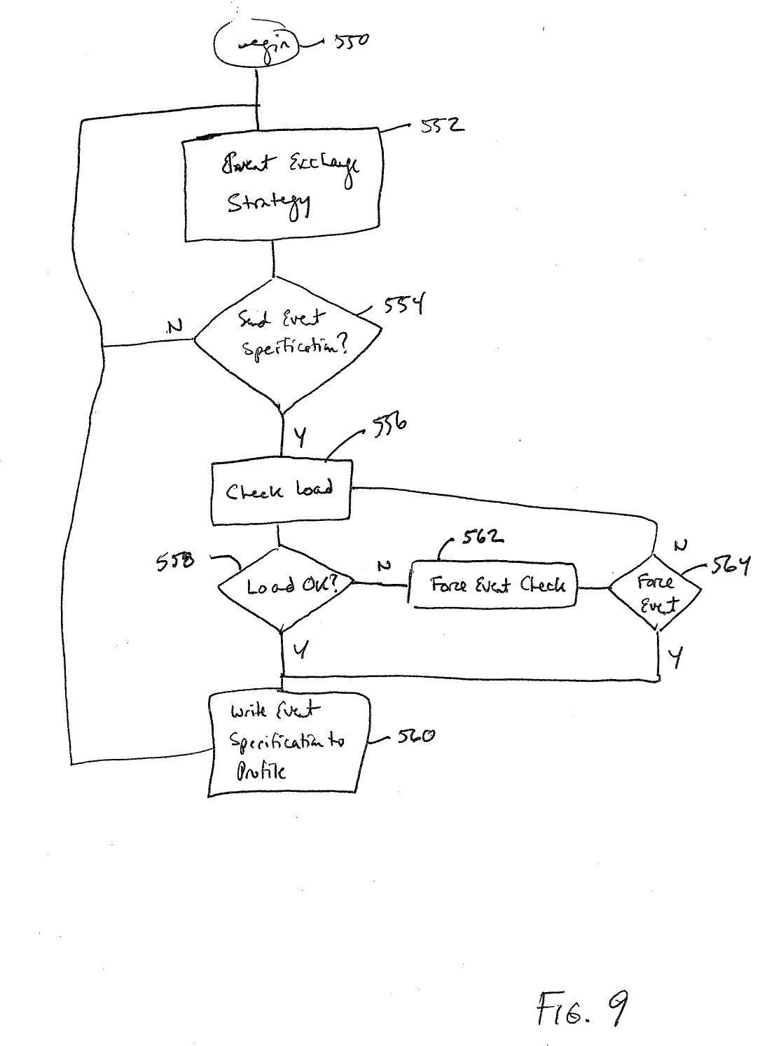

FIG. 9 illustrates the event specification queue management process, which is the remaining part of the process of FIG. 8, and specifically shows the handling of the event specifications that were routed to the event specification queue. The process is governed by an event specification queue management strategy and begins at block 550, and in block 552 an event exchange strategy check is applied. The component managing the event specification queue may be referred to as an event specification queue manager, which may be constituted by executable code.

The event exchange strategy determines whether to transmit an event specification from the event specification queue to the profile 206 in the database 204. Various rules or schemes can be used to control this strategy. For example, the transmission of events may occur based on a scheduler that manages the transmissions to occur on pre-set intervals. Likewise, the transmission may be triggered when a predetermined number of event specifications have been loaded into the queue, or if the bit size of the event specifications exceeds a threshold. Any combination of these parameters may be used to govern the release or transmission of the event specifications from the event specification queue. In block 554, if it is determined that an event specification should be sent, the process moves to block 556; and if it is not, then the process loops back to the event exchange strategy.

The event exchange strategy may be dictated by rules in the program governing this process, or it may be dictated by rules set forth in a specification contained in the rules database 210. Preferably, the rules are contained in a specification in the rules database 210, thus allowing the rules to be updated without re-programming the code for implementing the strategy.

In block 556, the process checks the load associated with the profile database 204 and/or the network (i.e., a load check strategy). Checking on the database load is desirable to learn whether the database can handle additional data without further effect on performance. Likewise, checking the network load may be desirable for similar reasons, particularly if the monitor 202 is connected through the network from a remote location to the database (which may especially be the case is numerous monitors are distributed within the network). As shown in block 558, if the load checked is below a threshold, then the process proceeds to block 560 where the event specification is written to the profile 206 for the associated resource. If the load checked is at or above the threshold, then the process will cycle through a force event check at block 562 governed by a force event strategy. In the force event check, the process determines whether transmission of the event specification should be forced (despite the load on the database), or whether it can wait. If the force event check determines that it can wait, then the method proceeds from block 564 back to check load at 556. If the force event check results in a decision to force transmission of the event specification, the method proceeds to block 560.

The force event check may be governed by one or more rules that may be the similar or different from the rules governing the event routing strategy 508 in FIG. 8. The force event check may indeed use the same rules, but they can be applied more currently in the event a change in the network occurs after loading the event specification queue causes the event specification to have a higher priority (i.e., a priority at or exceeding a predetermined event specification queue priority level). Alternatively, the event specification may use a different prioritization scheme which differentiates between the higher and lower priority event specifications in the queue (irrespective of the fact that those bypassing the event specification queue had an even higher priority).

The processes in FIGS. 8 and 9 may run continuously to continually update the profiles 206 in the database 204 and keep the database as current as possible.

The methodology for updating the profiles 206 in the profile database 204 may be implemented in any way, and the processes described in reference to FIGS. 8 and 9 is not intended to be limiting. The use of this process is beneficial in that it balances network and database load concerns against network prioritization and other concerns. However, it is not the sole way in which the present invention may be used.

The processes depicted in FIGS. 8 and 9 may be supplemented with an extension process that provides for retrieval of additional information. For example, upon receiving the event specification, the process may further determine whether the event specification meets one or more specified criteria. The criteria may include information data changes that are regarded to be important, such as configuration changes to a high priority resource, an error in a high priority resource, etc. Any type of criteria may be used, and such criteria may be stored in a specification in the rules database 210 and used for comparison to the event specification. If the process determines that such criteria are met, then the process may scan by transmitting a passive or temporary agent to retrieve additional information from the data in that resource. Thus, if the triggering event were a change in the configuration file of the resource, then the passive agent may be sent to retrieve the entire configuration file. Likewise, if the triggering event were an error or malfunction, then the passive agent may be sent to retrieve the entire configuration file and/or the log file, thus enabling a diagnosis of the error's cause to me made. This extended discovery process is beneficial, as it allows agent messages and event specifications on other issues to be processed in a normal manner, but ensures for certain types of events that more information is retrieved so that it may be examined appropriately. This extension process may be coupled with the alert processes noted above in some embodiments, as the same events that may trigger this extension process may also be events that warrant notifying a network administrator with an alert. The extension process may also inspect the agent message, rather than the event specification, to determine whether scanning should be used to retrieve additional information.

In any of the features or embodiments described hereinabove, the data concerning relations and connections between network resources may be retained in a topological profile of the entire network. The topological profile would reside in the profile database 204, and would be represent the topology of the network as a whole (or a sub-part of an entire network). In this topological profile, each network resource could be represented as a node in the topology, with connections and relations between the other network resources. This topological profile could be consulted in making any determinations described herein, and this profile of an individual resource could be regarded as the description of that resource as a node within the topological profile coupled with the description of its connections and relations. The functional information, such as event specifications, configuration file, etc., may be stored in a separate component profile for the resource, thus allowing this topological information to, be used as the profile consulted for load distribution, failover, alert generation, report generation, etc. The connections and relations between the various resources in this topological profile could be graded as weak or strong in accordance with rules set forth in the rules database. As such, all the connection and relation data and usage level data could be expressed in terms of the strength or weakness of the connection in this topological profile (e.g., a strong connection being a frequent usage, and a weak connection being an infrequent use). Such descriptions could be governed by rules in a rules database that semantically qualify the quantitative frequency of such usage in semantic terms of relative strength and weakness. Thus, in examining or updating the profile in the database, it could be either of these profiles, as in effect this architecture provides two profiles. These profiles can be taken together in an architectural sense as a single profile, as they collectively describe the resource both in functional terms (configuration, transactions, etc.) and in topological terms. Thus, the term “profile” is not intended to be limited to a single descriptive file per resource, and may include separate parts within the database.

The foregoing embodiments have been provided solely for illustrating the structural and functional principles of various aspects of the invention, and are in no way intended to be limiting. To the contrary, the present invention is intended to encompass all modifications, alterations, substitutions, and equivalents within the spirit and scope of the appended claims.

What is claimed:

1. A method for managing usage of service objects in a network comprising network resources including the service objects, each service object being configured to be used by other network resources to perform a specified function, the method being computer-implemented and comprising:
monitoring a usage of each service object to determine at least (a) a usage level for each service object, and (b) an identity of each network resource using the service object; and
storing the information determined by said monitoring, the information including for each service object at least (a) the usage level for each service object, and (b) the identity of each network resource using the service object.

2. A method according to claim 1, wherein the usage level comprises a frequency of usage of the service object, and a time when the service object was used.

3. A method according to claim 2, wherein the information stored for each service object also includes a location of the service object on the network.

4. A method according to claim 1, further comprising transmitting a report based on the stored information to a user interface in a textual, graphical, or textual and graphical format.

5. A method according to claim 3, further comprising determining, for each network resource using the service object, whether there is a direct loose connection or an indirect loose connection between the network resource and the service object; and storing a type of loose connection as part of the stored information.

6. A method according to claim 1, further comprising transmitting an alert to a user interface if the usage level of a given service object exceeds a predetermined threshold.

7. A method according to claim 1, further comprising transmitting an alert to a user interface if a number of network resources using a given service object exceeds a predetermined threshold.

8. A method according to claim 1, further comprising detecting a failure of a service object, and transmitting an alert to a user interface identifying each network resource using the service object based on the stored information.

9. A method according to claim 1, further comprising:
identifying one or more critical service objects, each critical service object being a service object meeting at least one of the criteria selected from the group consisting of (a) a usage level exceeding a predetermined usage level threshold, (b) a number of network resources using the service object exceeding a predetermined resource usage threshold, (c) a prioritization level, and (d) a time of when the object was used being within a predetermined period; and
transmitting a report to a user interface reporting the one or more critical service objects.

10. A method according to claim 1, further comprising:
identifying an overloaded service object meeting at least one of the criteria selected from the group consisting of (a) a usage level exceeding a predetermined usage level threshold or (b) a number of network resources using the service object exceeding a predetermined resource usage threshold;
locating or creating a copy of the overloaded service object; and
configuring one or more of the network resources using the overloaded service object to use the copy of the overloaded service object.

11. A method according to claim 10, wherein the locating and configuring acts occur automatically without user intervention.

12. A method according to claim 1, further comprising using the stored information to generate a failure analysis report for a given service object for transmission to a user interface for display in a textual, graphical, or textual and graphical format, the failure analysis report including information indicating the network resources that use the given service object and that would be affected by its failure.

13. A method according to claim 12, wherein the failure analysis report further includes information indicating a usage level for the given service object by each network resource.

14. A method according to claim 3, further comprising using the stored information to generate a failure analysis report for a given network location for transmission to a user interface for display in a textual, graphical, or textual and graphical format, the failure analysis report including information indicating one or more service objects at the given location, and the network resources that use the one or more service objects and that would be affected by failure of the given network location.

15. A method according to claim 14, wherein the failure analysis report further includes information indicating a usage level for the one or more service objects at the given network location by each network resource.

16. A method according to claim 1, wherein, if a given service object fails, the method further comprises:
detecting the failure of the failed service object; and
locating or creating a copy of the failed service object; and
configuring the network resources identified in the stored information as using the failed service object to use the copy of the failed service object.

17. A method according to claim 16, wherein the detecting, locating, and configuring acts occur automatically without user intervention.

18. A method according to claim 3, wherein, if a given network location fails, the method further comprises for each service object at the failed network location:
locating or creating a copy of the service object; and
configuring the network resources identified in the stored information as using the service object to use the copy of the service object.

19. A method according to claim 18, wherein the detecting, locating, and configuring acts occur automatically without user intervention.

20. A method according to claim 1, wherein the network comprises a profile database comprising profiles for each of the service objects, wherein the profile for each service object includes at least (a) the location of the service object, and (b) a resource usage list comprising the identity of each network resource using the service object,
wherein storing the information for each service object includes modifying the resource usage list in the service object's profile to include the identity of each network resource using the service object.

21. A method according to claim 20, wherein the profile for each service object further includes (c) a usage level for the service object,
wherein storing the information for each service object includes modifying the usage level in the service object's profile.

22. A method according to claim 20, further comprising reporting transmitting a report based on the stored information in the profiles to a user interface for display in a textual, graphical, or textual and graphical format.

23. A method according to claim 20, further comprising determining, for each service object, each direct loose connection or indirect loose connection between the service object and one or more network resources that use the service object; and
storing a type of loose connection for each network resource that uses the service object in the profile for the service object.

24. A method according to claim 23, further comprising transmitting a report to a user interface reporting each loose connection for one or more of the service objects.

25. A method according to claim 23, wherein determining an indirect loose connection between a service object and a network resource comprises analyzing the profiles in the profile database to identify a series of direct loose connections between the service object, the network resource, and at least one other network resource.

26. A method according to claim 21, further comprising analyzing the profiles for the service objects and transmitting an alert to a user interface if the usage level stored in the profile of a given service object exceeds a predetermined threshold for the given service object.

27. A method according to claim 20, further comprising analyzing the profiles for the service objects and transmitting an alert to a user interface if a number of network resources using a given service object as stored in its profile exceeds a predetermined threshold for the given service object.

28. A method according to claim 20, further comprising detecting a failure of a service object, and transmitting an alert identifying each network resource using the service object based on the information stored in the profile for the service object.

29. A method according to claim 23, further comprising analyzing the profiles for the service objects and transmitting an alert to a user interface if a number of loose connections stored in the profile for a given service object exceeds a predetermined threshold for the given service object.

30. A method according to claim 23, further comprising detecting a failure of a service object, and transmitting an alert identifying each network resource having a loose connection to the service object and the type of loose connection based on the information stored in the profile for the service object.

31. A method according to claim 21, further comprising:
identifying one or more critical service objects by analyzing the profiles thereof in the profile database, each critical service object being a service object meeting at least one of the criteria selected from the group consisting of (a) a usage level exceeding a predetermined usage level threshold, (b) a number of network resources using the service object exceeding a predetermined resource usage threshold, (c) a prioritization level, and (d) a time of when the object was used being within a predetermined period; and
transmitting a report to a user interface reporting the one or more critical service objects.

32. A method according to claim 23, further comprising:
identifying one or more critical service objects by analyzing the profiles thereof in the profile database, each critical service object being a service object having a number of loose connections exceeding a predetermined loose connection threshold; and
transmitting a report to a user interface reporting the one or more critical service objects.

33. A method according to claim 21, further comprising analyzing the profiles to identify an overloaded service object meeting at least one of the criteria selected from the group consisting of: (a) a usage level exceeding a predetermined usage level threshold, or (b) a number of network resources using the service object exceeding a predetermined resource usage threshold;
locating or creating a copy of the overloaded service object;
configuring one or more of the network resources using the overloaded service object to use the copy of the overloaded service object; and
modifying the profile for the overloaded service object to delete the one or more network resources from the resource usage list thereof, and modifying the profile for the copy of the given service object to include the one or more network resources in the resource usage list thereof.

34. A method according to claim 33, wherein the locating, configuring and modifying acts occur automatically without user intervention.

35. A method according to claim 23, further comprising analyzing the profiles to identify a given service object with a number of loose connections exceeding a predetermined threshold;
locating or creating a copy of the given service object;
configuring one or more of the network resources directly loosely connected to the given service object to use the copy of the given service object; and
modifying the profile for the given service object to delete the one or more network resources from the resource usage list thereof, and modifying the profile for the copy of the given service object to include the one or more network resources in the resource usage list thereof.

36. A method according to claim 35, wherein the locating, configuring and modifying acts occur automatically without user intervention.

37. A method according to claim 20, further comprising reporting via a user interface a failure analysis report for a given service object for display in a textual, graphical, or textual and graphical format using the information stored in the profile for the given service object, the failure analysis report including information indicating the network resources that use the given service object and that would be affected by its failure.

38. A method according to claim 21, further comprising generating a failure analysis report for a given service object for transmission to a user interface for display in a textual, graphical, or textual and graphical format using the information stored in the profile for the given service object, the failure analysis report including information indicating the network resources that use the given service object and that would be affected by its failure, and information indicating a usage of the given service object by each network resource.

39. A method according to claim 20, further comprising generating a failure analysis report for a given network location for transmission to a user interface for display in a textual, graphical, or textual and graphical format using the information stored in the profiles for the one or more service objects at the given network location, the failure analysis report including information indicating the one or more service objects at the given location, and the network resources that use the one or more service objects and that would be affected by failure of the given network location.

40. A method according to claim 21, further comprising generating a failure analysis report for a given network location for transmission to a user interface for display in a textual, graphical, or textual and graphical format using the information stored in the profiles for the one or more service objects at the given network location, the failure analysis report including information indicating the one or more service objects at the given location, and the network resources that use the one or more service objects and that would be affected by failure of the given network location, and information indicating a usage of the one or more service objects at the given network location by each network resource.

41. A method according to claim 23, wherein, if a given service object fails, the method further comprises:
detecting the failure of the failed service object;
locating or creating a copy of the failed service object;
configuring the one or more network resources identified in the profile as directly loosely connected to the failed service object to use the copy of the failed service object; and
modifying the profile for the given service object to delete the one or more network resources from the resource usage list thereof, and modifying the profile for the copy of the given service object to include the one or more network resources in the resource usage list thereof each as a direct loose connection.

42. A method according to claim 41, wherein the detecting, locating, configuring and modifying acts occur automatically without user intervention.

43. A method according to claim 23, wherein, if a given network location fails, the method further comprises for each service object at the network location:
locating or creating a copy of the service object;
configuring the one or more network resources identified in the profile as directly loosely connected to the service object to use the copy of the service object;
modifying the profile for the given service object to delete the one or more network resources from the resource usage list thereof, and modifying the profile for the copy of the given service object to include the one or more network resources in the resource usage list thereof each as a direct loose connection.

44. A method according to claim 43, wherein the detecting, locating, configuring and modifying acts occur automatically without user intervention.

45. A method according to claim 25, further comprising, for each service object, determining each direct relation or indirect relation between the service object and one or more network resources on which the service object operates;
storing the one or more network resources directly or indirectly related to the service object in a relation resource list in the profile for the service object.

46. A method according to claim 45, further comprising storing a type of relation in the relation resource list for the one or more network resources directly or indirectly related to the service object.

47. A method according to claim 45, wherein determining an indirect relation between a service object and a network resource comprises analyzing the profiles in the profile database to identify a series of direct relations between the service object, the network resource, and at least one other network resource.

48. A method according to claim 45, further comprising identifying one or more critical network resources by:
identifying one or more critical service objects by analyzing the profiles thereof in the profile database, each critical service object meeting at least one of the following criteria selected from the group consisting of (a) a usage level exceeding a predetermined usage level threshold or (b) a number of network resources using the service object exceeding a predetermined resource usage threshold, (c) a prioritization level, and (d) a time of when the object was used being within a predetermined period; and
transmitting a report to a user interface reporting the one or more network resources with which each of the one or more critical service objects is directly or indirectly related.

49. A method according to claim 45, further comprising identifying one or more critical network resources by:
identifying one or more critical service objects by analyzing the profiles thereof in the profile database, each critical service object having a number of loose connections exceeding a predetermined threshold; and
transmitting a report to a user interface reporting the one or more network resources with which each of the one or more critical service objects is directly or indirectly related.

50. A method according to claim 45, further comprising generating a failure analysis report for a given network resource for transmission to a user interface for display in a textual, graphical, or textual and graphical format using the information stored in the profile for each service object directly or indirectly related to the service object, the failure analysis report including information indicating each directly or indirectly related service object and the network resources that use each directly or indirectly related service object and that would be affected by failure of the given network resource.

51. A method according to claim 45, further comprising generating a failure analysis report for a given network resource for transmission to a user interface for display in a textual, graphical, or textual and graphical format using the information stored in the profile for each service object directly or indirectly related to the service object, the failure analysis report including information indicating each directly or indirectly related service object, the network resources that use the each directly or indirectly related service object and that would be affected by its failure, and information indicating a usage of directly or indirectly related service object by each network resource.

52. A method according to claim 45, wherein, if a given network resource fails, the method further comprises:
detecting the failure of the failed network resource;
locating or creating a copy of one or more of the service objects directly or indirectly related to the failed network resource;
configuring the one or more network resources identified in the profile as directly loosely connected to each of the one or more of the service objects to use the copy of the each of the one or more service objects.

53. A method according to claim 52, wherein the detecting, locating, and configuring acts occur automatically without user intervention.

54. A method for managing usage of process objects in a network comprising network resources including service objects and the process objects, each service object being configured to performed a specified function and further being configured to be used by other network resources including the process objects, each process object comprising executable code for performing a process including using one or more of the service objects, the method being computer-implemented and comprising:
monitoring a usage of each process object to determine at least (a) a usage level for the process object, (b) an identity of each network resource using the process object, and (c) an identity of each service object used by the process object; and
storing the information determined by said monitoring, the information including for each process object at least (a) the usage level for the process object, (b) the identity of each network resource using the process object, and (c) the identity of each service object used by the process object.

55. A method according to claim 54, further comprising, for each service object used by the process object:
(i) monitoring a usage of each service object to determine at least (a) a usage level for each service object, and (b) an identity of each network resource using the service object; and
(ii) storing information determined by said monitoring, the information including for each service object at least (a) the usage level for each service object, and (b) the identity of each network resource using the service object.

56. A method according to claim 54, wherein the information stored for each process object also includes a location of the process object on the network.

57. A method according to claim 54, further comprising transmitting a report to a user interface reporting the stored information for each process object for display in a textual, graphical, or textual and graphical format.

58. A method according to claim 55, further comprising transmitting a report to a user interface reporting the stored information for each process object for display in a textual, graphical, or textual and graphical format.

59. A method according to claim 55, further comprising determining for each network resource using the process object, whether there is a loose connection or an indirect loose connection between the network resource and the process object; and storing a type of loose connection as part of the stored information.

60. A method according to claim 54, further comprising transmitting an alert to a user interface if the usage level of a given process object exceeds a predetermined threshold.

61. A method according to claim 54, further comprising transmitting an alert to a user interface if the usage level of a service object used by a given process object exceeds a predetermined threshold.

62. A method according to claim 54, further comprising transmitting an alert to a user interface if a number of network resources using a given process object exceeds a predetermined threshold.

63. A method according to claim 54, further comprising transmitting an alert to a user interface if a number of network resources using a service object also used by a given process object exceeds a predetermined threshold.

64. A method according to claim 54, further comprising detecting a failure of a process object, and transmitting an alert to a user interface identifying each network resource using the process object based on the stored information.

65. A method according to claim 54, further comprising:
identifying one or more critical process objects, each critical process object being a process object meeting at least one of the criteria selected from the group consisting of (a) a usage level exceeding a predetermined usage level threshold and (b) a number of network resources using the process object exceeding a predetermined resource usage threshold; and
transmitting a report to a user interface reporting the one or more critical process objects.

66. A method according to claim 55, further comprising using the stored information to generate a failure analysis report for a given process object for transmission to a user interface for display in a textual, graphical, or textual and graphical format, the failure analysis report including information indicating the network resources that use the given process object and that would be affected by its failure.

67. A method according to claim 66, wherein the failure analysis report further includes information indicating a usage level for the given process object by each network resource.

68. A method according to claim 55, further comprising using the stored information to generate a failure analysis report for a given network location for transmission to a user interface for display in a textual, graphical, or textual and graphical format, the failure analysis report including information indicating one or more process objects at the given location, and the network resources that use the one or more process objects and that would be affected by failure of the given network location.

69. A method according to claim 68, wherein the failure analysis report further includes information indicating a frequency of usage of the one or more process objects at the given network location by each network resource.

70. A system for managing usage of service objects in a network comprising network resources including the service objects, each service object being configured to be used by other network resources to perform a specified function, the system comprising:
a monitor for monitoring a usage of each service object to determine at least (a) a usage level for each service object, and (b) an identity of each network resource using the service object; and
a database for storing the information determined by said monitoring, the information including for each service object at least (a) the usage level for each service object, and (b) the identity of each network resource using the service object.

71. A system according to claim 70, wherein the monitor is configured to monitor the usage level comprising a frequency of usage of the service object, and a time when the service object was used.

72. A system according to claim 71, wherein database also stores the information including a location of the service object on the network.

73. A system according to claim 70, further comprising a report generator, the report generator being configured to generate a report for transmission to a user interface for reporting the stored information in a textual, graphical, or textual and graphical format.

74. A system according to claim 72, further comprising a report generator, the report generator being configured to generate a report for transmission to a user interface for reporting the stored information in a textual, graphical, or textual and graphical format.

75. A system according to claim 70, further comprising an alert generator, the alert generator being configured to transmit an alert to a user interface if the usage level of a given service object exceeds a predetermined threshold.

76. A system according to claim 70, further comprising an alert generator, the alert generator being configured to detect a failure of a service object, and transmit an alert to a user interface identifying each network resource using the service object based on the stored information.

77. A system according to claim 70, further comprising:
a critical service object manager configured to identify one or more critical service objects, each critical service object being a service object meeting at least one of the criteria selected from the group consisting of (a) a usage level exceeding a predetermined usage level threshold, (b) a number of network resources using the service object exceeding a predetermined resource usage threshold, (c) a prioritization level, and (d) a time of when the object was used being within a predetermined period; and
a report generator for generating a report for transmission to a user interface for reporting the one or more critical service objects.

78. A system according to claim 70, further comprising an overloaded re-distribution manager configured to:
identify an overloaded service object meeting at least one of the criteria selected from the group consisting of (a) a usage level exceeding a predetermined usage level threshold or (b) a number of network resources using the service object exceeding a predetermined resource usage threshold;
locate or create a copy of the overloaded service object; and
configure one or more of the network resources using the overloaded service object to use the copy of the overloaded service object.

79. A system according to claim 70, further comprising a report generator configured to generate a failure analysis report for a given service object using the stored information for transmission to a user interface for display in a textual, graphical, or textual and graphical format, the failure analysis report including information indicating the network resources that use the given service object and that would be affected by its failure.

80. A system according to claim 79, wherein the report generator is configured to generate the failure analysis report to further include information indicating a usage level for the given service object by each network resource.

81. A system according to claim 72, further comprising a report generator configured to generate a failure analysis report for a given network location using the stored information for transmission to a user interface for display in a textual, graphical, or textual and graphical format, the failure analysis report including information indicating one or more service objects at the given location, and the network resources that use the one or more service objects and that would be affected by failure of the given network location.

82. A system according to claim 81, wherein the report generator is configured to generate the failure analysis report to further include information indicating a usage level for the one or more service objects at the given network location by each network resource.

83. A system according to claim 82, wherein the database is a profile database comprising profiles for each of the service objects, wherein the profile for each service object includes at least (a) the location of the service object, and (b) a resource usage list comprising the identity of each network resource using the service object,
wherein a database manager is configured to store the information for each service object by modifying the resource usage list in the service object's profile to include the identity of each network resource using the service object.

84. A system according to claim 83, wherein the profile for each service object further includes (c) a usage level for the service object,
wherein the database manager is configured to store the information for each service object by also modifying the usage level in the service object's profile.

85. A system according to claim 84, wherein the monitor is configured to monitor the usage level by monitoring a frequency of usage of the service object and a time when the service object was used.

86. A system according to claim 84, wherein database also stores the information including a location of the service object on the network.

87. A system according to claim 84, further comprising an alert generator configured to analyze the profiles for the service objects and transmit an alert to a user interface if the usage level of a given service object as stored in its profile exceeds a predetermined threshold.

88. A system according to claim 83, further comprising an alert generator configured to analyze the profiles for the service objects and configured to transmit an alert via the user interface if a number of network resources using a given service object as stored in its profile exceeds a predetermined threshold.

89. A system according to claim 84, further comprising an alert generator configured to, in response to detecting the failure of given service object, transmit an alert to a user interface identifying each network resource using the given service object based on the information stored in its profile.

90. A system according to claim 84, further comprising:
a critical service object manager for identifying one or more critical service objects by analyzing the profiles thereof in the profile database, each critical service object being a service object meeting at least one of the criteria selected from the group consisting of (a) a usage level exceeding a predetermined usage level threshold, (b) a number of network resources using the service object exceeding a predetermined resource usage threshold, (c) a prioritization level, and (d) a time of when the object was used being within a predetermined period; and
a report generator for generating a report for transmission to a user interface for reporting the one or more critical service objects.

91. A system according to claim 85, further comprising an overload re-distribution manager configured to:
determine if the usage level of or number of network resources using the given service object exceeds a predetermined threshold;
locate or create a copy of the given service object;
configure one or more of the network resources using the given service object to use the copy of the given service object; and
modify the profile for the given service object to delete the one or more network resources from the resource usage list thereof, and modifying the profile for the copy of the given service object to include the one or more network resources in the resource usage list thereof.

92. A system according to claim 85, further comprising an object failure manager configured to:
detect a failure of a service object;
locate or create a copy of the failed service object;
configure the one or more network resources identified the profile as directly loosely connected to the failed service object to use the copy of the failed service object; and
modify the profile for the given service object to delete the one or more network resources from the resource usage list thereof, and modifying the profile for the copy of the given service object to include the one or more network resources in the resource usage list thereof each as a direct loose connection.

93. A system for managing usage of process objects in a network comprising network resources including service objects and the process objects, each service object being configured to performed a specified function and further being configured to be used by other network resources including the process objects, each process object comprising executable code for using one or more of the service objects, the system comprising:
a monitor for monitoring a usage of each process object to determine at least (a) a usage level for the process object, (b) an identity of each network resource using the process object, and (c) an identity of each service object used by the process object; and
a database for storing the information determined by said monitoring, the information including for each process object at least (a) the usage level for the process object, (b) the identity of each network resource using the process object, and (c) the identity of each service object used by the process object.

94. A system according to claim 93, wherein, for each service object used by the process object:
(i) the monitor is configured to monitor a usage of each service object to determine at least (a) a usage level for each service object, and (b) an identity of each network resource using the service object; and
(ii) the database is configured to store information determined by said monitoring, the information including for each service object at least (a) the usage level for each service object, and (b) the identity of each network resource using the service object.

95. A system according to claim 93, wherein the information stored for each process object also includes a location of the process object on the network.

96. A system according to claim 93, further comprising an alert generator configured to transmit an alert to a user interface if the usage level of a given process object exceeds a predetermined threshold.

97. A system according to claim 93, further comprising an alert generator configured to transmit an alert via the user interface if the usage level of a service object used by a given process object exceeds a predetermined threshold.

98. A system according to claim 93, further comprising an alert generator configured to transmit an alert via the user interface if a number of network resources using a service object also used by a given process object exceeds a predetermined threshold.

99. A system according to claim 93, further comprising:
a critical process object manager for identifying one or more critical process objects, each critical process object being a process object meeting at least one of the criteria selected from the group consisting of (a) a usage level exceeding a predetermined usage level threshold and (b) a number of network resources using the process object exceeding a predetermined resource usage threshold; and
a report generator for generating a report for transmission to a user interface for reporting one or more critical process objects.
